(19) United States
(12) Patent Application Publication
(10) Pub. No.: US 2017/0286829 A1
(43) Pub. Date: Oct. 5, 2017

(54) Event-driven Learning and Reward Modulation with Spike Timing Dependent Plasticity in Neuromorphic Computers

(71) Applicant: Intel Corporation, Santa Clara, CA (US)

(72) Inventors: Gregory K. Chen, Hillsboro, OR (US); Raghavan Kumar, Hillsboro, OR (US); Huseyin E. Sumbul, Hillsboro, OR (US)

(21) Appl. No.: 15/088,198

(22) Filed: Apr. 1, 2016

(51) Int. Cl. G06N 3/08; G06N 3/063

(52) U.S. Cl. CPC G06N 3/08; G06N 3/0635

(57) ABSTRACT

Systems and methods for event-driven learning with spike timing dependent plasticity in neuromorphic computers are disclosed. A neuromorphic processor includes a synapse coupled to a pre-synaptic neuron and coupled to a post-synaptic neuron, the synapse including a synapse memory to store a synapse weight and synapse spike timing dependent plasticity (STDP) circuit coupled to the synapse memory. The pre-synaptic neuron includes a pre-synaptic neuron memory to store a pre-synaptic neuron spike history and a pre-synaptic neuron STDP circuit coupled to the pre-synaptic neuron memory, the pre-synaptic neuron STDP circuit to, in response to the pre-synaptic neuron firing, initiate performing long term potentiation. The post-synaptic neuron includes a post-synaptic neuron memory storing a post-synaptic neuron spike history and a post-synaptic neuron STDP circuit coupled to the post-synaptic neuron memory to, in response to the post-synaptic neuron firing, initiate performing long term depression.

### FIELD OF THE INVENTION

The present disclosure pertains to the field of processing logic, neuromorphic processors, microprocessors, and associated instruction set architecture that, when executed by the processor or other processing logic, perform logical, mathematical, or other functional operations.

### DESCRIPTION OF RELATED ART

A neuromorphic processor may be used (alone or in conjunction with another type of processor) to estimate or approximate functions that can depend on a large number of inputs and are generally unknown. For example, neuromorphic processors may allow systems to perform face recognition, to extract information from large data sets, and to perform object detection tasks that may be beyond of the scope of traditionally programmed solutions. Neuromorphic processors may provide a path to computational intelligence by allowing machines to learn features from training data, when programming features in explicitly becomes too complex.

A neuromorphic processor may operate in a manner similar to biological neural networks (such as a central nervous system of an animal). Specifically, a neuromorphic processor may include a network of interconnected “neurons” that may exchange data between one another. Each connection between a neuron may be referred to as a “synapse.” A neuron may have one output that may fan out to one or more synapses. At each synapse, the output of a neuron may be multiplied by a synapse weight. This weighted output of a neuron may be transmitted via the one or more synapses to an input of one or more neurons. Neurons may sum (or integrate) these received inputs. When this sum (referred to as a “membrane potential”) exceeds a threshold value, a neuron may generate an output (or “fire”) from the neuron using a transfer function such as a sigmoid or threshold function. That output may then be passed via one or more synapses to one or more neurons as an input. Once a neuron fires, it may disregard previously received input information, thereby resetting the neuron.

A synapse weight may be selected, modified, or adjusted, making neural nets adaptive to inputs and capable of learning. Accordingly, a neuromorphic processor may not require a setup program, but rather may be a learning architecture that may be trained through iterative adjustment of synapse weights.

### DESCRIPTION OF THE FIGURES

Embodiments are illustrated by way of example and not limitation in the Figures of the accompanying drawings:

FIG. 1A is a block diagram of an exemplary computer system formed with a processor that may include execution units to execute an instruction, in accordance with embodiments of the present disclosure;

FIG. 1B illustrates a data processing system, in accordance with embodiments of the present disclosure;

FIG. 1C illustrates other embodiments of a data processing system for performing text string comparison operations;

FIG. 2 is a block diagram of the micro-architecture for a processor that may include logic circuits to perform instructions, in accordance with embodiments of the present disclosure;

FIG. 3A is a block diagram of a processor, in accordance with embodiments of the present disclosure;

FIG. 3B is a block diagram of an example implementation of a core, in accordance with embodiments of the present disclosure;

FIG. 4 is a block diagram of a system, in accordance with embodiments of the present disclosure;

FIG. 5 is a block diagram of a second system, in accordance with embodiments of the present disclosure;

FIG. 6 is a block diagram of a third system in accordance with embodiments of the present disclosure;

FIG. 7 is a block diagram of a system-on-a-chip, in accordance with embodiments of the present disclosure;

FIG. 8 is a block diagram of an electronic device for utilizing a processor, in accordance with embodiments of the present disclosure;

FIG. 9 is a block diagram of a system including a neuromorphic processor, in accordance with embodiments of the present disclosure;

FIG. 10 is a block diagram of an example embodiment of a neuromorphic processor, in accordance with embodiments of the present disclosure;

FIG. 11 is a block diagram of a synapse, in accordance with embodiments of the present disclosure;

FIG. 12 is a block diagram of a neuron, in accordance with embodiments of the present disclosure;

FIG. 13 is an operational block diagram of long term potentiation in a neuromorphic processor, in accordance with embodiments of the present disclosure;

FIG. 14 is an operational block diagram of long term depression in a neuromorphic processor, in accordance with embodiments of the present disclosure;

FIG. 15 is a block diagram of a neuromorphic processor operable to perform reward-based STDP, in accordance with embodiments of the present disclosure;

FIG. 16 is a flow chart of a method for performing long term potentiation in a neuromorphic processor, in accordance with embodiments of the present disclosure;

FIG. 17 is a flow chart of a method for performing long term depression in a neuromorphic processor, in accordance with embodiments of the present disclosure; and

FIG. 18 is a flow chart of a method for performing event-based spike timing dependent plasticity (STDP) in a neuromorphic processor, in accordance with embodiments of the present disclosure.

### DETAILED DESCRIPTION

The following description describes a neuromorphic processor. A neuromorphic processor may operate alone or in conjunction with another processor. In the following description, numerous specific details such as processing logic, processor types, micro-architectural conditions, events, enablement mechanisms, and the like are set forth in order to provide a more thorough understanding of embodiments of the present disclosure. It will be appreciated, however, by one skilled in the art that the embodiments may be practiced without such specific details. Additionally, some well-known structures, circuits, and the like have not been shown in detail to avoid unnecessarily obscuring embodiments of the present disclosure.

Although the following embodiments are described with reference to a processor, other embodiments are applicable to other types of integrated circuits and logic devices. Similar techniques and teachings of embodiments of the present disclosure may be applied to other types of circuits or semiconductor devices that may benefit from higher pipeline throughput and improved performance. The teachings of embodiments of the present disclosure are applicable to any processor or machine that performs data manipulations. However, the embodiments are not limited to processors or machines that perform 512-bit, 256-bit, 128-bit, 64-bit, 32-bit, or 16-bit data operations and may be applied to any processor and machine in which manipulation or management of data may be performed. In addition, the following description provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

Although the below examples describe instruction handling and distribution in the context of execution units and logic circuits, other embodiments of the present disclosure may be accomplished by way of a data or instructions stored on a machine-readable, tangible medium, which when performed by a machine cause the machine to perform functions consistent with at least one embodiment of the disclosure. In one embodiment, functions associated with embodiments of the present disclosure are embodied in machine-executable instructions. The instructions may be used to cause a general-purpose or special-purpose processor that may be programmed with the instructions to perform the steps of the present disclosure. Embodiments of the present disclosure may be provided as a computer program product or software which may include a machine or computer-readable medium having stored thereon instructions which may be used to program a computer (or other electronic devices) to perform one or more operations in accordance with embodiments of the present disclosure. Furthermore, steps of embodiments of the present disclosure might be performed by specific hardware components that contain fixed-function logic for performing the steps, or by any combination of programmed computer components and fixed-function hardware components.

Instructions used to program logic to perform embodiments of the present disclosure may be stored within a memory in the system, such as DRAM, cache, flash memory, or other storage. Furthermore, the instructions may be distributed via a network or by way of other computer-readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium may include any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as may be useful in simulations, the hardware may be represented using a hardware description language or another functional description language. Additionally, a circuit level model with logic and/or transistor gates may be produced at some stages of the design process. Furthermore, designs, at some stage, may reach a level of data representing the physical placement of various devices in the hardware model. In cases wherein some semiconductor fabrication techniques are used, the data representing the hardware model may be the data specifying the presence or absence of various features on different mask layers for masks used to produce the integrated circuit. In any representation of the design, the data may be stored in any form of a machine-readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or retransmission of the electrical signal is performed, a new copy may be made. Thus, a communication provider or a network provider may store on a tangible, machine-readable medium, at least temporarily, an article, such as information encoded into a carrier wave, embodying techniques of embodiments of the present disclosure.

In modern processors, a number of different execution units may be used to process and execute a variety of code and instructions. Some instructions may be quicker to complete while others may take a number of clock cycles to complete. The faster the throughput of instructions, the better the overall performance of the processor. Thus it would be advantageous to have as many instructions execute as fast as possible. However, there may be certain instructions that have greater complexity and require more in terms of execution time and processor resources, such as floating point instructions, load/store operations, data moves, etc.

As more computer systems are used in internet, text, and multimedia applications, additional processor support has been introduced over time. In one embodiment, an instruction set may be associated with one or more computer architectures, including data types, instructions, register architecture, addressing modes, memory architecture, interrupt and exception handling, and external input and output (I/O).

In one embodiment, the instruction set architecture (ISA) may be implemented by one or more micro-architectures, which may include processor logic and circuits used to implement one or more instruction sets. Accordingly, processors with different micro-architectures may share at least a portion of a common instruction set. For example, Intel® Pentium 4 processors, Intel® Core™ processors, and processors from Advanced Micro Devices, Inc. of Sunnyvale Calif. implement nearly identical versions of the x86 instruction set (with some extensions that have been added with newer versions), but have different internal designs. Similarly, processors designed by other processor development companies, such as ARM Holdings, Ltd., MIPS, or their licensees or adopters, may share at least a portion a common instruction set, but may include different processor designs. For example, the same register architecture of the ISA may be implemented in different ways in different micro-architectures using new or well-known techniques, including dedicated physical registers, one or more dynamically allocated physical registers using a register renaming mechanism (e.g., the use of a Register Alias Table (RAT), a Reorder Buffer (ROB) and a retirement register file. In one embodiment, registers may include one or more registers, register architectures, register files, or other register sets that may or may not be addressable by a software programmer.

An instruction may include one or more instruction formats. In one embodiment, an instruction format may indicate various fields (number of bits, location of bits, etc.) to specify, among other things, the operation to be performed and the operands on which that operation will be performed. In a further embodiment, some instruction formats may be further defined by instruction templates (or sub-formats). For example, the instruction templates of a given instruction format may be defined to have different subsets of the instruction format's fields and/or defined to have a given field interpreted differently. In one embodiment, an instruction may be expressed using an instruction format (and, if defined, in a given one of the instruction templates of that instruction format) and specifies or indicates the operation and the operands upon which the operation will operate.

Scientific, financial, auto-vectorized general purpose, RMS (recognition, mining, and synthesis), and visual and multimedia applications (e.g., 2D/3D graphics, image processing, video compression/decompression, voice recognition algorithms and audio manipulation) may require the same operation to be performed on a large number of data items. In one embodiment, Single Instruction Multiple Data (SIMD) refers to a type of instruction that causes a processor to perform an operation on multiple data elements. SIMD technology may be used in processors that may logically divide the bits in a register into a number of fixed-sized or variable-sized data elements, each of which represents a separate value. For example, in one embodiment, the bits in a 64-bit register may be organized as a source operand containing four separate 16-bit data elements, each of which represents a separate 16-bit value. This type of data may be referred to as ‘packed’ data type or ‘vector’ data type, and operands of this data type may be referred to as packed data operands or vector operands. In one embodiment, a packed data item or vector may be a sequence of packed data elements stored within a single register, and a packed data operand or a vector operand may a source or destination operand of a SIMD instruction (or ‘packed data instruction’ or a ‘vector instruction’). In one embodiment, a SIMD instruction specifies a single vector operation to be performed on two source vector operands to generate a destination vector operand (also referred to as a result vector operand) of the same or different size, with the same or different number of data elements, and in the same or different data element order.

SIMD technology, such as that employed by the Intel® Core™ processors having an instruction set including x86, MMX™, Streaming SIMD Extensions (SSE), SSE2, SSE3, SSE4.1, and SSE4.2 instructions, ARM processors, such as the ARM Cortex® family of processors having an instruction set including the Vector Floating Point (VFP) and/or NEON instructions, and MIPS processors, such as the Loongson family of processors developed by the Institute of Computing Technology (ICT) of the Chinese Academy of Sciences, has enabled a significant improvement in application performance (Core™ and MMX™ are registered trademarks or trademarks of Intel Corporation of Santa Clara, Calif.).

In one embodiment, destination and source registers/data may be generic terms to represent the source and destination of the corresponding data or operation. In some embodiments, they may be implemented by registers, memory, or other storage areas having other names or functions than those depicted. For example, in one embodiment, “DEST1” may be a temporary storage register or other storage area, whereas “SRC1” and “SRC2” may be a first and second source storage register or other storage area, and so forth. In other embodiments, two or more of the SRC and DEST storage areas may correspond to different data storage elements within the same storage area (e.g., a SIMD register). In one embodiment, one of the source registers may also act as a destination register by, for example, writing back the result of an operation performed on the first and second source data to one of the two source registers serving as a destination registers.

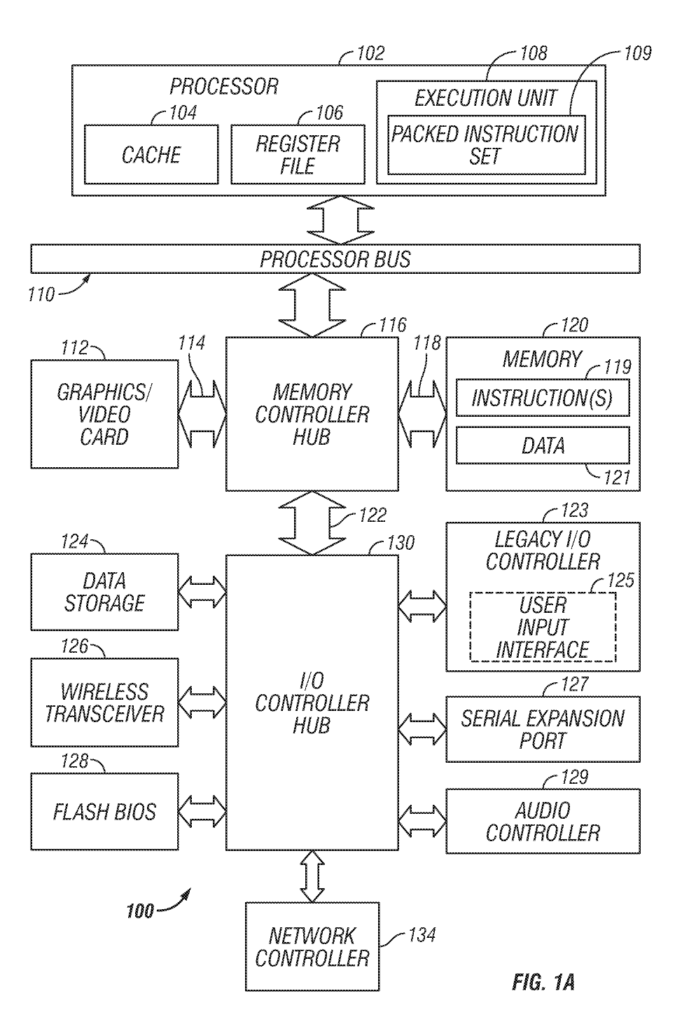

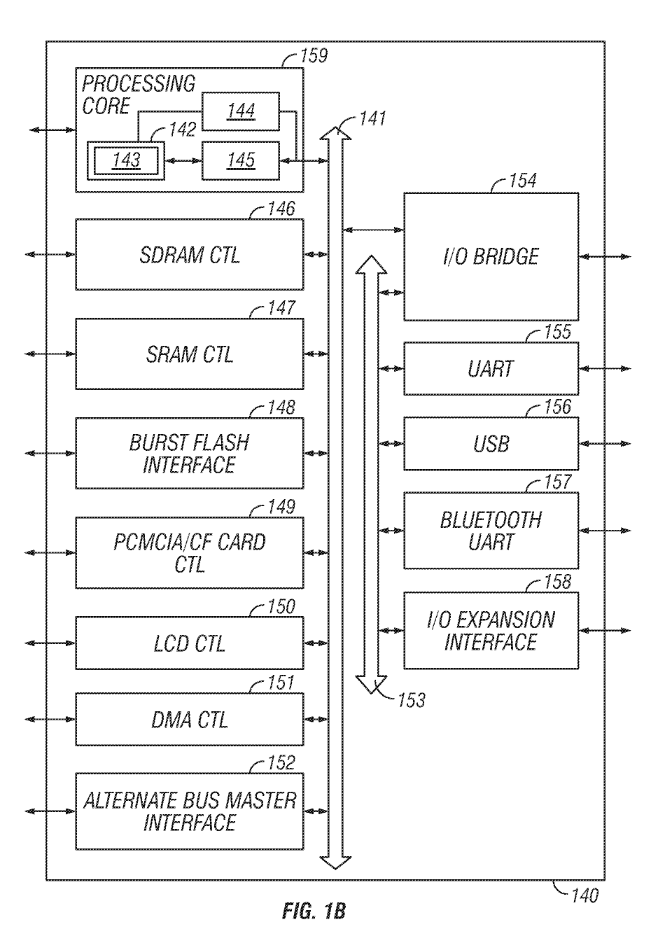

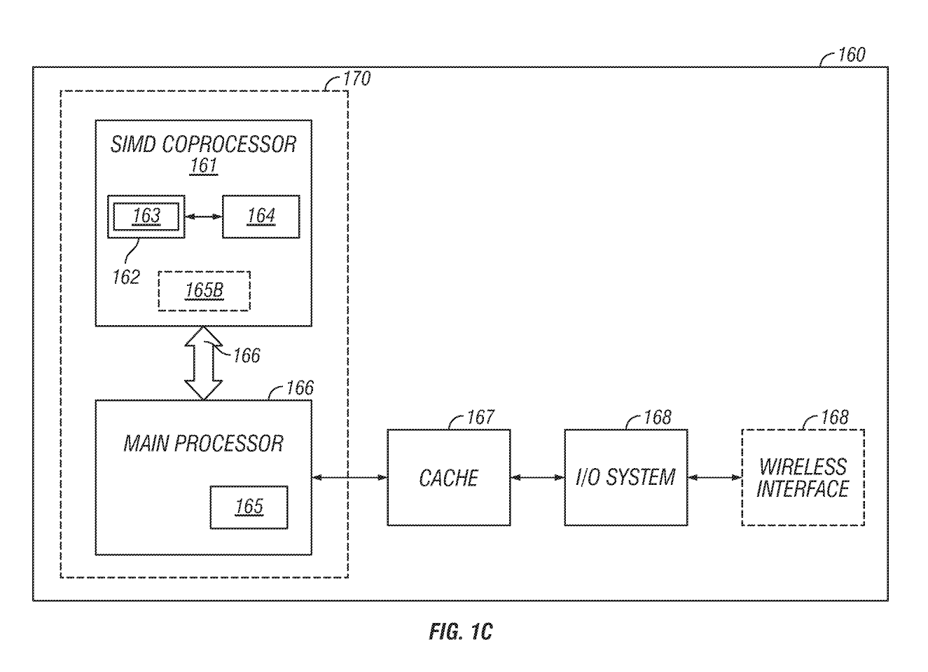

FIG. 1A is a block diagram of an exemplary computer system formed with a processor that may include execution units to execute an instruction, in accordance with embodiments of the present disclosure. System 100 may include a component, such as a processor 102 to employ execution units including logic to perform algorithms for process data, in accordance with the present disclosure, such as in the embodiment described herein. System 100 may be representative of processing systems based on the PENTIUM® III, PENTIUM® 4,Xeon™, Itanium®, XScale™ and/or StrongARM™ microprocessors available from Intel Corporation of Santa Clara, California, although other systems (including PCs having other microprocessors, engineering workstations, set-top boxes and the like) may also be used. In one embodiment, sample system 100 may execute a version of the WINDOWS' operating system available from Microsoft Corporation of Redmond, Wash., although other operating systems (UNIX and Linux for example), embedded software, and/or graphical user interfaces, may also be used. Thus, embodiments of the present disclosure are not limited to any specific combination of hardware circuitry and software.

Embodiments are not limited to computer systems. Embodiments of the present disclosure may be used in other devices such as handheld devices and embedded applications. Some examples of handheld devices include cellular phones, Internet Protocol devices, digital cameras, personal digital assistants (PDAs), and handheld PCs. Embedded applications may include a micro controller, a digital signal processor (DSP), system on a chip, network computers (NetPC), set-top boxes, network hubs, wide area network (WAN) switches, or any other system that may perform one or more instructions in accordance with at least one embodiment.

Computer system 100 may include a processor 102 that may include one or more execution units 108 to perform an algorithm to perform at least one instruction in accordance with one embodiment of the present disclosure. One embodiment may be described in the context of a single processor desktop or server system, but other embodiments may be included in a multiprocessor system. System 100 may be an example of a ‘hub’ system architecture. System 100 may include a processor 102 for processing data signals. Processor 102 may include a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In one embodiment, processor 102 may be coupled to a processor bus 110 that may transmit data signals between processor 102 and other components in system 100. The elements of system 100 may perform conventional functions that are well known to those familiar with the art.

In one embodiment, processor 102 may include a Level 1 (L1) internal cache memory 104. Depending on the architecture, the processor 102 may have a single internal cache or multiple levels of internal cache. In another embodiment, the cache memory may reside external to processor 102. Other embodiments may also include a combination of both internal and external caches depending on the particular implementation and needs. Register file 106 may store different types of data in various registers including integer registers, floating point registers, status registers, and instruction pointer register.

Execution unit 108, including logic to perform integer and floating point operations, also resides in processor 102. Processor 102 may also include a microcode (ucode) ROM that stores microcode for certain macroinstructions. In one embodiment, execution unit 108 may include logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications may be accelerated and executed more efficiently by using the full width of a processor's data bus for performing operations on packed data. This may eliminate the need to transfer smaller units of data across the processor's data bus to perform one or more operations one data element at a time.

Embodiments of an execution unit 108 may also be used in micro controllers, embedded processors, graphics devices, DSPs, and other types of logic circuits. System 100 may include a memory 120. Memory 120 may be implemented as a Dynamic Random Access Memory (DRAM) device, a Static Random Access Memory (SRAM) device, flash memory device, or other memory device. Memory 120 may store instructions and/or data represented by data signals that may be executed by processor 102.

A system logic chip 116 may be coupled to processor bus 110 and memory 120. System logic chip 116 may include a memory controller hub (MCH). Processor 102 may communicate with MCH 116 via a processor bus 110. MCH 116 may provide a high bandwidth memory path 118 to memory 120 for instruction and data storage and for storage of graphics commands, data and textures. MCH 116 may direct data signals between processor 102, memory 120, and other components in system 100 and to bridge the data signals between processor bus 110, memory 120, and system I/O 122. In some embodiments, the system logic chip 116 may provide a graphics port for coupling to a graphics controller 112. MCH 116 may be coupled to memory 120 through a memory interface 118. Graphics card 112 may be coupled to MCH 116 through an Accelerated Graphics Port (AGP) interconnect 114.

System 100 may use a proprietary hub interface bus 122 to couple MCH 116 to I/O controller hub (ICH) 130. In one embodiment, ICH 130 may provide direct connections to some I/O devices via a local I/O bus. The local I/O bus may include a high-speed I/O bus for connecting peripherals to memory 120, chipset, and processor 102. Examples may include the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. Data storage device 124 may comprise a hard disk drive, a floppy disk drive, a CD-ROM device, a flash memory device, or other mass storage device.

For another embodiment of a system, an instruction in accordance with one embodiment may be used with a system on a chip. One embodiment of a system on a chip comprises of a processor and a memory. The memory for one such system may include a flash memory. The flash memory may be located on the same die as the processor and other system components. Additionally, other logic blocks such as a memory controller or graphics controller may also be located on a system on a chip.

FIG. 1B illustrates a data processing system 140 which implements the principles of embodiments of the present disclosure. It will be readily appreciated by one of skill in the art that the embodiments described herein may operate with alternative processing systems without departure from the scope of embodiments of the disclosure.

Computer system 140 comprises a processing core 159 for performing at least one instruction in accordance with one embodiment. In one embodiment, processing core 159 represents a processing unit of any type of architecture, including but not limited to a CISC, a RISC or a VLIW-type architecture. Processing core 159 may also be suitable for manufacture in one or more process technologies and by being represented on a machine-readable media in sufficient detail, may be suitable to facilitate said manufacture.

Processing core 159 comprises an execution unit 142, a set of register files 145, and a decoder 144. Processing core 159 may also include additional circuitry (not shown) which may be unnecessary to the understanding of embodiments of the present disclosure. Execution unit 142 may execute instructions received by processing core 159. In addition to performing typical processor instructions, execution unit 142 may perform instructions in packed instruction set 143 for performing operations on packed data formats. Packed instruction set 143 may include instructions for performing embodiments of the disclosure and other packed instructions. Execution unit 142 may be coupled to register file 145 by an internal bus. Register file 145 may represent a storage area on processing core 159 for storing information, including data. As previously mentioned, it is understood that the storage area may store the packed data might not be critical. Execution unit 142 may be coupled to decoder 144. Decoder 144 may decode instructions received by processing core 159 into control signals and/or microcode entry points. In response to these control signals and/or microcode entry points, execution unit 142 performs the appropriate operations. In one embodiment, the decoder may interpret the opcode of the instruction, which will indicate what operation should be performed on the corresponding data indicated within the instruction.

Processing core 159 may be coupled with bus 141 for communicating with various other system devices, which may include but are not limited to, for example, Synchronous Dynamic Random Access Memory (SDRAM) control 146, Static Random Access Memory (SRAM) control 147, burst flash memory interface 148, Personal Computer Memory Card International Association (PCMCIA)/Compact Flash (CF) card control 149, Liquid Crystal Display (LCD) control 150, Direct Memory Access (DMA) controller 151, and alternative bus master interface 152. In one embodiment, data processing system 140 may also comprise an I/O bridge 154 for communicating with various I/O devices via an I/O bus 153. Such I/O devices may include but are not limited to, for example, Universal Asynchronous Receiver/Transmitter (UART) 155, Universal Serial Bus (USB) 156, Bluetooth wireless UART 157 and I/O expansion interface 158.

One embodiment of data processing system 140 provides for mobile, network and/or wireless communications and a processing core 159 that may perform SIMD operations including a text string comparison operation. Processing core 159 may be programmed with various audio, video, imaging and communications algorithms including discrete transformations such as a Walsh-Hadamard transform, a fast Fourier transform (FFT), a discrete cosine transform (DCT), and their respective inverse transforms; compression/decompression techniques such as color space transformation, video encode motion estimation or video decode motion compensation; and modulation/demodulation (MODEM) functions such as pulse coded modulation (PCM).

FIG. 1C illustrates other embodiments of a data processing system that performs SIMD text string comparison operations. In one embodiment, data processing system 160 may include a main processor 166, a SIMD coprocessor 161, a cache memory 167, and an input/output system 168. Input/output system 168 may optionally be coupled to a wireless interface 169. SIMD coprocessor 161 may perform operations including instructions in accordance with one embodiment. In one embodiment, processing core 170 may be suitable for manufacture in one or more process technologies and by being represented on a machine-readable media in sufficient detail, may be suitable to facilitate the manufacture of all or part of data processing system 160 including processing core 170.

In one embodiment, SIMD coprocessor 161 comprises an execution unit 162 and a set of register files 164. One embodiment of main processor 165 comprises a decoder 165 to recognize instructions of instruction set 163 including instructions in accordance with one embodiment for execution by execution unit 162. In other embodiments, SIMD coprocessor 161 also comprises at least part of decoder 165 to decode instructions of instruction set 163. Processing core 170 may also include additional circuitry (not shown) which may be unnecessary to the understanding of embodiments of the present disclosure.

In operation, main processor 166 executes a stream of data processing instructions that control data processing operations of a general type including interactions with cache memory 167, and input/output system 168. Embedded within the stream of data processing instructions may be SIMD coprocessor instructions. Decoder 165 of main processor 166 recognizes these SIMD coprocessor instructions as being of a type that should be executed by an attached SIMD coprocessor 161. Accordingly, main processor 166 issues these SIMD coprocessor instructions (or control signals representing SIMD coprocessor instructions) on the coprocessor bus 166. From coprocessor bus 166, these instructions may be received by any attached SIMD coprocessors. In this case, SIMD coprocessor 161 may accept and execute any received SIMD coprocessor instructions intended for it.

Data may be received via wireless interface 169 for processing by the SIMD coprocessor instructions. For one example, voice communication may be received in the form of a digital signal, which may be processed by the SIMD coprocessor instructions to regenerate digital audio samples representative of the voice communications. For another example, compressed audio and/or video may be received in the form of a digital bit stream, which may be processed by the SIMD coprocessor instructions to regenerate digital audio samples and/or motion video frames. In one embodiment of processing core 170, main processor 166, and a SIMD coprocessor 161 may be integrated into a single processing core 170 comprising an execution unit 162, a set of register files 164, and a decoder 165 to recognize instructions of instruction set 163 including instructions in accordance with one embodiment.

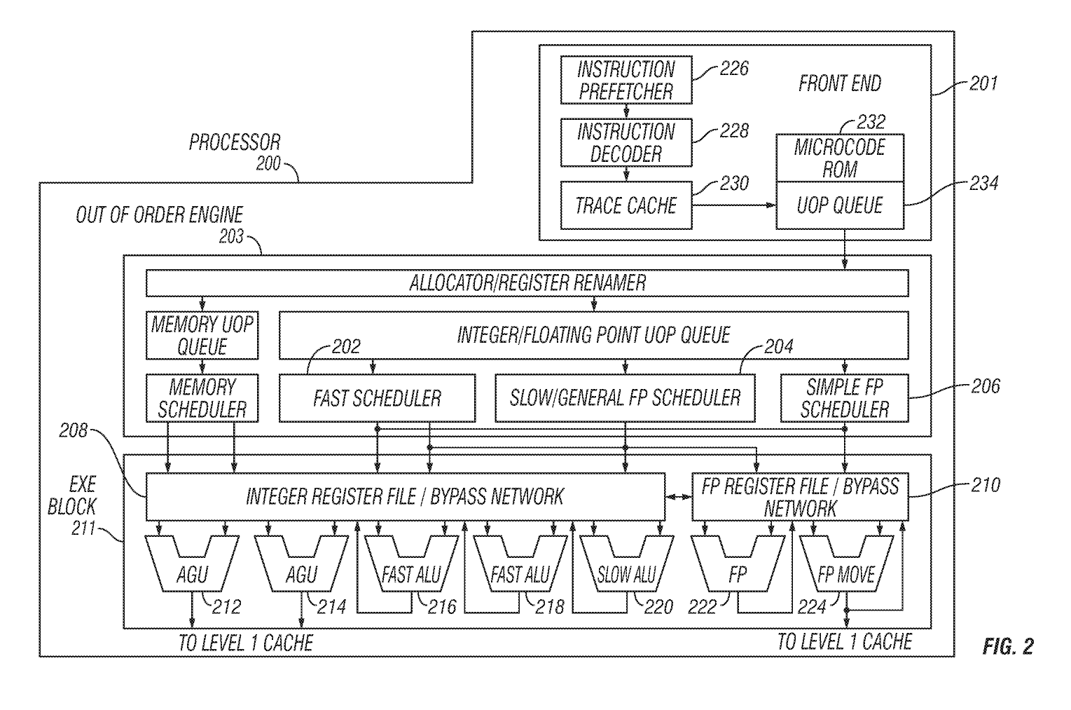

FIG. 2 is a block diagram of the micro-architecture for a processor 200 that may include logic circuits to perform instructions, in accordance with embodiments of the present disclosure. In some embodiments, an instruction in accordance with one embodiment may be implemented to operate on data elements having sizes of byte, word, doubleword, quadword, etc., as well as datatypes, such as single and double precision integer and floating point datatypes. In one embodiment, in-order front end 201 may implement a part of processor 200 that may fetch instructions to be executed and prepares the instructions to be used later in the processor pipeline. Front end 201 may include several units. In one embodiment, instruction prefetcher 226 fetches instructions from memory and feeds the instructions to an instruction decoder 228 which in turn decodes or interprets the instructions. For example, in one embodiment, the decoder decodes a received instruction into one or more operations called “micro-instructions” or “micro-operations” (also called micro op or uops) that the machine may execute. In other embodiments, the decoder parses the instruction into an opcode and corresponding data and control fields that may be used by the micro-architecture to perform operations in accordance with one embodiment. In one embodiment, trace cache 230 may assemble decoded uops into program ordered sequences or traces in uop queue 234 for execution. When trace cache 230 encounters a complex instruction, microcode ROM 232 provides the uops needed to complete the operation.

Some instructions may be converted into a single micro-op, whereas others need several micro-ops to complete the full operation. In one embodiment, if more than four micro-ops are needed to complete an instruction, decoder 228 may access microcode ROM 232 to perform the instruction. In one embodiment, an instruction may be decoded into a small number of micro-ops for processing at instruction decoder 228. In another embodiment, an instruction may be stored within microcode ROM 232 should a number of micro-ops be needed to accomplish the operation. Trace cache 230 refers to an entry point programmable logic array (PLA) to determine a correct micro-instruction pointer for reading the micro-code sequences to complete one or more instructions in accordance with one embodiment from micro-code ROM 232. After microcode ROM 232 finishes sequencing micro-ops for an instruction, front end 201 of the machine may resume fetching micro-ops from trace cache 230.

Out-of-order execution engine 203 may prepare instructions for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 202, slow/general floating point scheduler 204, and simple floating point scheduler 206. Uop schedulers 202, 204, 206, determine when a uop is ready to execute based on the readiness of their dependent input register operand sources and the availability of the execution resources the uops need to complete their operation. Fast scheduler 202 of one embodiment may schedule on each half of the main clock cycle while the other schedulers may only schedule once per main processor clock cycle. The schedulers arbitrate for the dispatch ports to schedule uops for execution.

Register files 208, 210 may be arranged between schedulers 202, 204, 206, and execution units 212, 214, 216, 218, 220, 222, 224 in execution block 211. Each of register files 208, 210 perform integer and floating point operations, respectively. Each register file 208, 210, may include a bypass network that may bypass or forward just completed results that have not yet been written into the register file to new dependent uops. Integer register file 208 and floating point register file 210 may communicate data with the other. In one embodiment, integer register file 208 may be split into two separate register files, one register file for low-order thirty-two bits of data and a second register file for high order thirty-two bits of data. Floating point register file 210 may include 128-bit wide entries because floating point instructions typically have operands from 64 to 128 bits in width.

Execution block 211 may contain execution units 212, 214, 216, 218, 220, 222, 224. Execution units 212, 214, 216, 218, 220, 222, 224 may execute the instructions. Execution block 211 may include register files 208, 210 that store the integer and floating point data operand values that the micro-instructions need to execute. In one embodiment, processor 200 may comprise a number of execution units: address generation unit (AGU) 212, AGU 214, fast Arithmetic Logic Unit (ALU) 216, fast ALU 218, slow ALU 220, floating point ALU 222, floating point move unit 224. In another embodiment, floating point execution blocks 222, 224, may execute floating point, MMX, SIMD, and SSE, or other operations. In yet another embodiment, floating point ALU 222 may include a 64-bit by 64-bit floating point divider to execute divide, square root, and remainder micro-ops. In various embodiments, instructions involving a floating point value may be handled with the floating point hardware. In one embodiment, ALU operations may be passed to high-speed ALU execution units 216, 218. High-speed ALUs 216, 218 may execute fast operations with an effective latency of half a clock cycle. In one embodiment, most complex integer operations go to slow ALU 220 as slow ALU 220 may include integer execution hardware for long-latency type of operations, such as a multiplier, shifts, flag logic, and branch processing. Memory load/store operations may be executed by AGUs 212, 214. In one embodiment, integer ALUs 216, 218, 220 may perform integer operations on 64-bit data operands. In other embodiments, ALUs 216, 218, 220 may be implemented to support a variety of data bit sizes including sixteen, thirty-two, 128, 256, etc. Similarly, floating point units 222, 224 may be implemented to support a range of operands having bits of various widths. In one embodiment, floating point units 222, 224, may operate on 128-bit wide packed data operands in conjunction with SIMD and multimedia instructions.

In one embodiment, uops schedulers 202, 204, 206, dispatch dependent operations before the parent load has finished executing. As uops may be speculatively scheduled and executed in processor 200, processor 200 may also include logic to handle memory misses. If a data load misses in the data cache, there may be dependent operations in flight in the pipeline that have left the scheduler with temporarily incorrect data. A replay mechanism tracks and re-executes instructions that use incorrect data. Only the dependent operations might need to be replayed and the independent ones may be allowed to complete. The schedulers and replay mechanism of one embodiment of a processor may also be designed to catch instruction sequences for text string comparison operations.

The term “registers” may refer to the on-board processor storage locations that may be used as part of instructions to identify operands. In other words, registers may be those that may be usable from the outside of the processor (from a programmer's perspective). However, in some embodiments registers might not be limited to a particular type of circuit. Rather, a register may store data, provide data, and perform the functions described herein. The registers described herein may be implemented by circuitry within a processor using any number of different techniques, such as dedicated physical registers, dynamically allocated physical registers using register renaming, combinations of dedicated and dynamically allocated physical registers, etc. In one embodiment, integer registers store 32-bit integer data. A register file of one embodiment also contains eight multimedia SIMD registers for packed data. For the discussions below, the registers may be understood to be data registers designed to hold packed data, such as 64-bit wide MMX™ registers (also referred to as ‘mm’ registers in some instances) in microprocessors enabled with MMX technology from Intel Corporation of Santa Clara, Calif. These MMX registers, available in both integer and floating point forms, may operate with packed data elements that accompany SIMD and SSE instructions. Similarly, 128-bit wide XMM registers relating to SSE2, SSE3, SSE4, or beyond (referred to generically as “SSEx”) technology may hold such packed data operands. In one embodiment, in storing packed data and integer data, the registers do not need to differentiate between the two data types. In one embodiment, integer and floating point may be contained in the same register file or different register files. Furthermore, in one embodiment, floating point and integer data may be stored in different registers or the same registers.

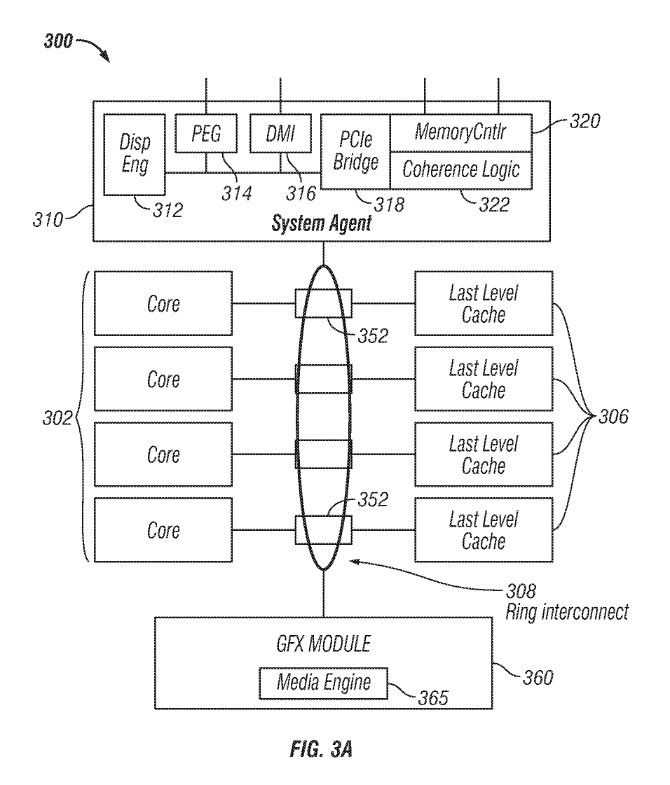

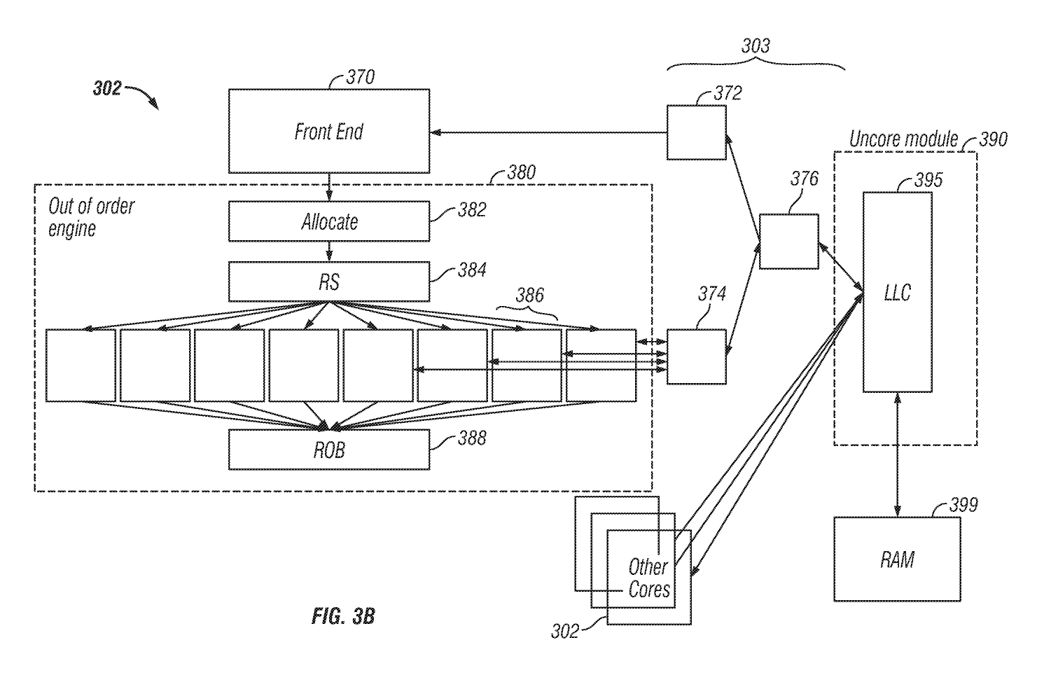

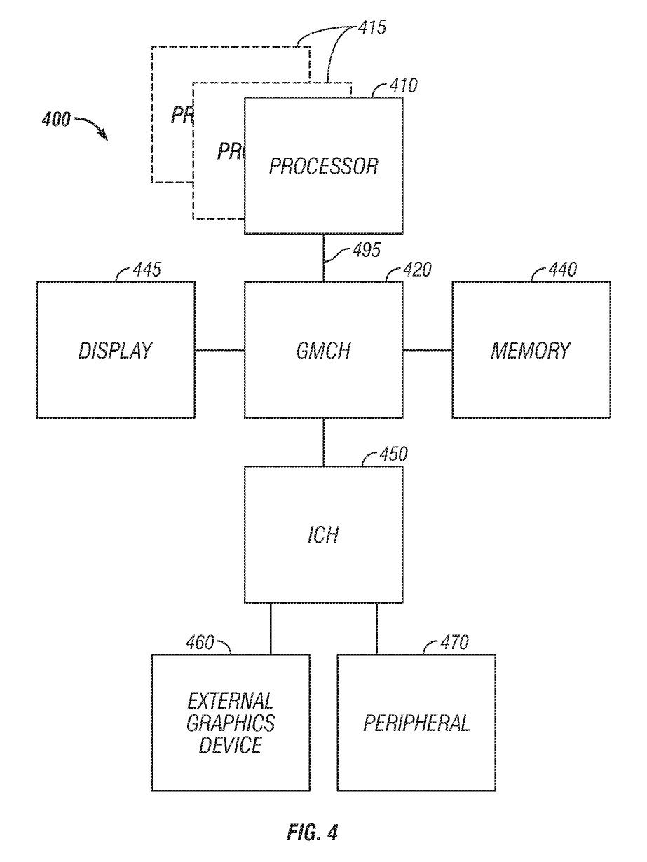

FIGS. 3-5 may illustrate exemplary systems suitable for including processor 300, while FIG. 4 may illustrate an exemplary System on a Chip (SoC) that may include one or more of cores 302. Other system designs and implementations known in the arts for laptops, desktops, handheld PCs, personal digital assistants, engineering workstations, servers, network devices, network hubs, switches, embedded processors, DSPs, graphics devices, video game devices, set-top boxes, micro controllers, cell phones, portable media players, hand held devices, and various other electronic devices, may also be suitable. In general, a huge variety of systems or electronic devices that incorporate a processor and/or other execution logic as disclosed herein may be generally suitable.

FIG. 4 illustrates a block diagram of a system 400, in accordance with embodiments of the present disclosure. System 400 may include one or more processors 410, 415, which may be coupled to Graphics Memory Controller Hub (GMCH) 420. The optional nature of additional processors 415 is denoted in FIG. 4 with broken lines.

Each processor 410, 415 may be some version of processor 300. However, it should be noted that integrated graphics logic and integrated memory control units might not exist in processors 410, 415. FIG. 4 illustrates that GMCH 420 may be coupled to a memory 440 that may be, for example, a dynamic random access memory (DRAM). The DRAM may, for at least one embodiment, be associated with a non-volatile cache.

GMCH 420 may be a chipset, or a portion of a chipset. GMCH 420 may communicate with processors 410, 415 and control interaction between processors 410, 415 and memory 440. GMCH 420 may also act as an accelerated bus interface between the processors 410, 415 and other elements of system 400. In one embodiment, GMCH 420 communicates with processors 410, 415 via a multi-drop bus, such as a frontside bus (FSB) 495.

Furthermore, GMCH 420 may be coupled to a display 445 (such as a flat panel display). In one embodiment, GMCH 420 may include an integrated graphics accelerator. GMCH 420 may be further coupled to an input/output (I/O) controller hub (ICH) 450, which may be used to couple various peripheral devices to system 400. External graphics device 460 may include be a discrete graphics device coupled to ICH 450 along with another peripheral device 470.

In other embodiments, additional or different processors may also be present in system 400. For example, additional processors 410, 415 may include additional processors that may be the same as processor 410, additional processors that may be heterogeneous or asymmetric to processor 410, accelerators (such as, e.g., graphics accelerators or digital signal processing (DSP) units), field programmable gate arrays, or any other processor. There may be a variety of differences between the physical resources 410, 415 in terms of a spectrum of metrics of merit including architectural, micro-architectural, thermal, power consumption characteristics, and the like. These differences may effectively manifest themselves as asymmetry and heterogeneity amongst processors 410, 415. For at least one embodiment, various processors 410, 415 may reside in the same die package.

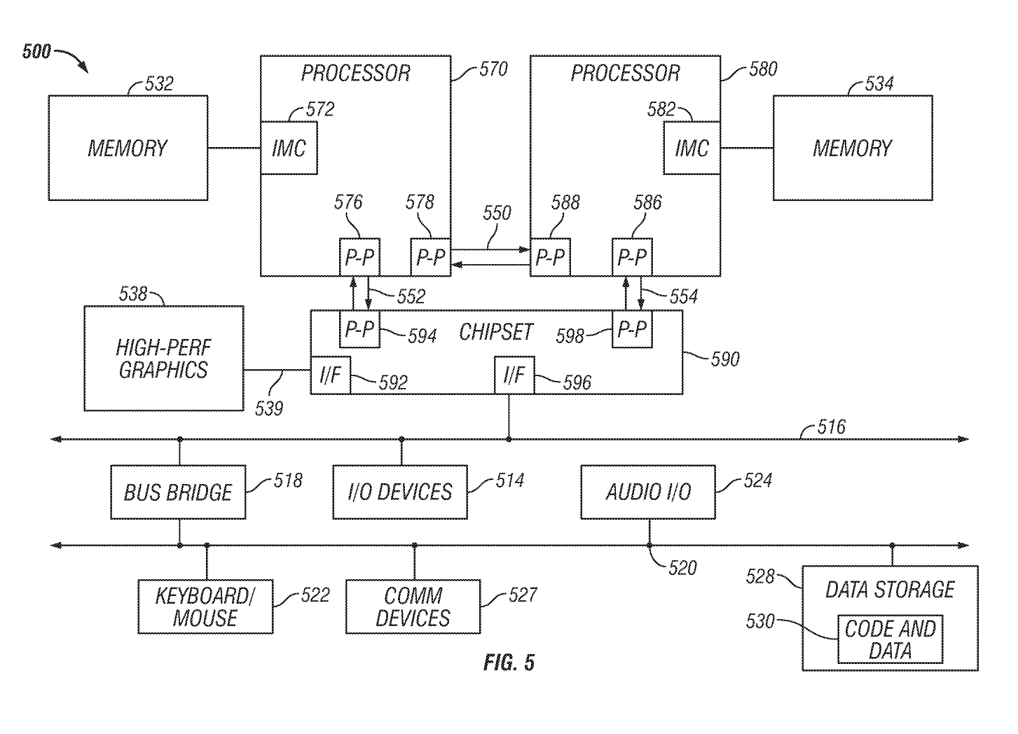

FIG. 5 illustrates a block diagram of a second system 500, in accordance with embodiments of the present disclosure. As shown in FIG. 5, multiprocessor system 500 may include a point-to-point interconnect system, and may include a first processor 570 and a second processor 580 coupled via a point-to-point interconnect 550. Each of processors 570 and 580 may be some version of processor 300 as one or more of processors 410,615.

While FIG. 5 may illustrate two processors 570, 580, it is to be understood that the scope of the present disclosure is not so limited. In other embodiments, one or more additional processors may be present in a given processor.

Processors 570 and 580 are shown including integrated memory controller units 572 and 582, respectively. Processor 570 may also include as part of its bus controller units point-to-point (P-P) interfaces 576 and 578; similarly, second processor 580 may include P-P interfaces 586 and 588. Processors 570, 580 may exchange information via a point-to-point (P-P) interface 550 using P-P interface circuits 578, 588. As shown in FIG. 5, IMCs 572 and 582 may couple the processors to respective memories, namely a memory 532 and a memory 534, which in one embodiment may be portions of main memory locally attached to the respective processors.

Processors 570, 580 may each exchange information with a chipset 590 via individual P-P interfaces 552, 554 using point to point interface circuits 576, 594, 586, 598. In one embodiment, chipset 590 may also exchange information with a high-performance graphics circuit 538 via a high-performance graphics interface 539.

A shared cache (not shown) may be included in either processor or outside of both processors, yet connected with the processors via P-P interconnect, such that either or both processors' local cache information may be stored in the shared cache if a processor is placed into a low power mode.

Chipset 590 may be coupled to a first bus 516 via an interface 596. In one embodiment, first bus 516 may be a Peripheral Component Interconnect (PCI) bus, or a bus such as a PCI Express bus or another third generation I/O interconnect bus, although the scope of the present disclosure is not so limited.

As shown in FIG. 5, various I/O devices 514 may be coupled to first bus 516, along with a bus bridge 518 which couples first bus 516 to a second bus 520. In one embodiment, second bus 520 may be a Low Pin Count (LPC) bus. Various devices may be coupled to second bus 520 including, for example, a keyboard and/or mouse 522, communication devices 527 and a storage unit 528 such as a disk drive or other mass storage device which may include instructions/code and data 530, in one embodiment. Further, an audio I/O 524 may be coupled to second bus 520. Note that other architectures may be possible. For example, instead of the point-to-point architecture of FIG. 5, a system may implement a multi-drop bus or other such architecture.

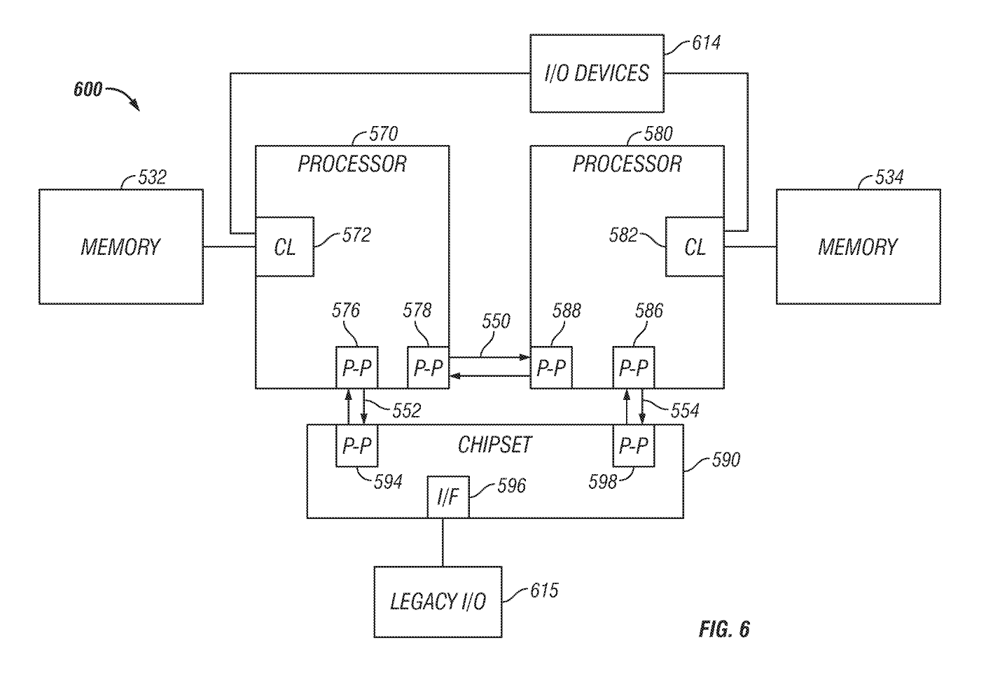

FIG. 6 illustrates a block diagram of a third system 600 in accordance with embodiments of the present disclosure. Like elements in FIGS. 5 and 6 bear like reference numerals, and certain aspects of FIG. 5 have been omitted from FIG. 6 in order to avoid obscuring other aspects of FIG. 6.

FIG. 6 illustrates that processors 670, 680 may include integrated memory and I/O Control Logic (“CL”) 672 and 682, respectively. For at least one embodiment, CL 672, 682 may include integrated memory controller units such as that described above in connection with FIGS. 3-5. In addition. CL 672, 682 may also include I/O control logic. FIG. 6 illustrates that not only memories 632, 634 may be coupled to CL 672, 682, but also that I/O devices 614 may also be coupled to control logic 672, 682. Legacy I/O devices 615 may be coupled to chipset 690.

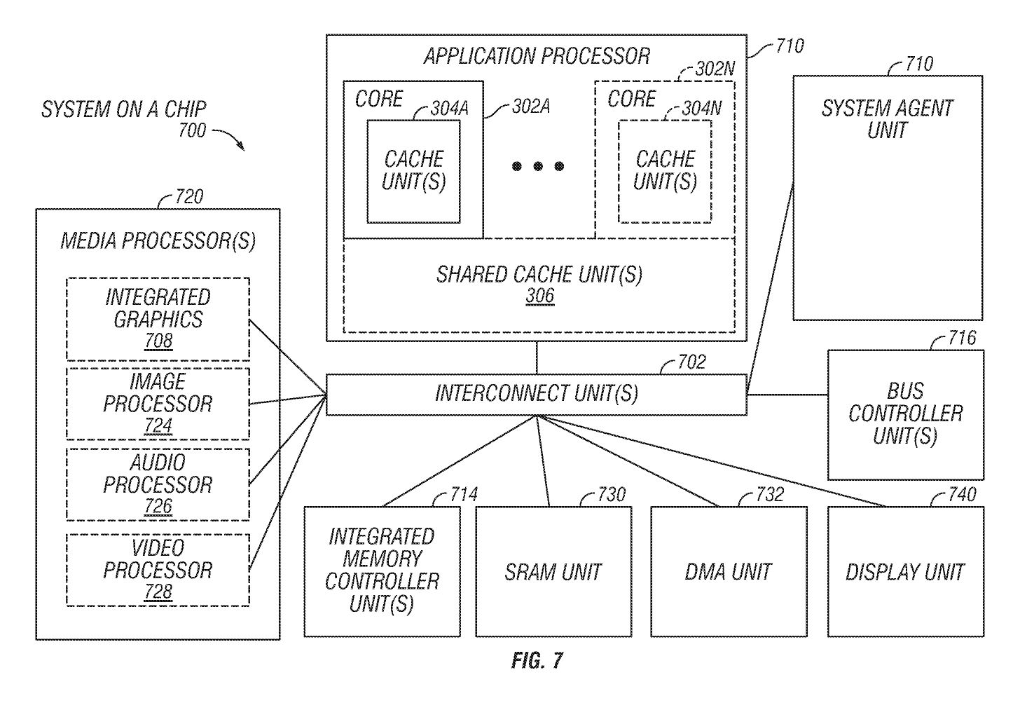

FIG. 7 illustrates a block diagram of a SoC 700, in accordance with embodiments of the present disclosure. Similar elements in FIG. 3 bear like reference numerals. Also, dashed lined boxes may represent optional features on more advanced SoCs. An interconnect units 702 may be coupled to: an application processor 710 which may include a set of one or more cores 702A-N and shared cache units 706; a system agent unit 711; a bus controller units 716; an integrated memory controller units 714; a set or one or more media processors 720 which may include integrated graphics logic 708, an image processor 724 for providing still and/or video camera functionality, an audio processor 726 for providing hardware audio acceleration, and a video processor 728 for providing video encode/decode acceleration; an SRAM unit 730; a DMA unit 732; and a display unit 740 for coupling to one or more external displays.

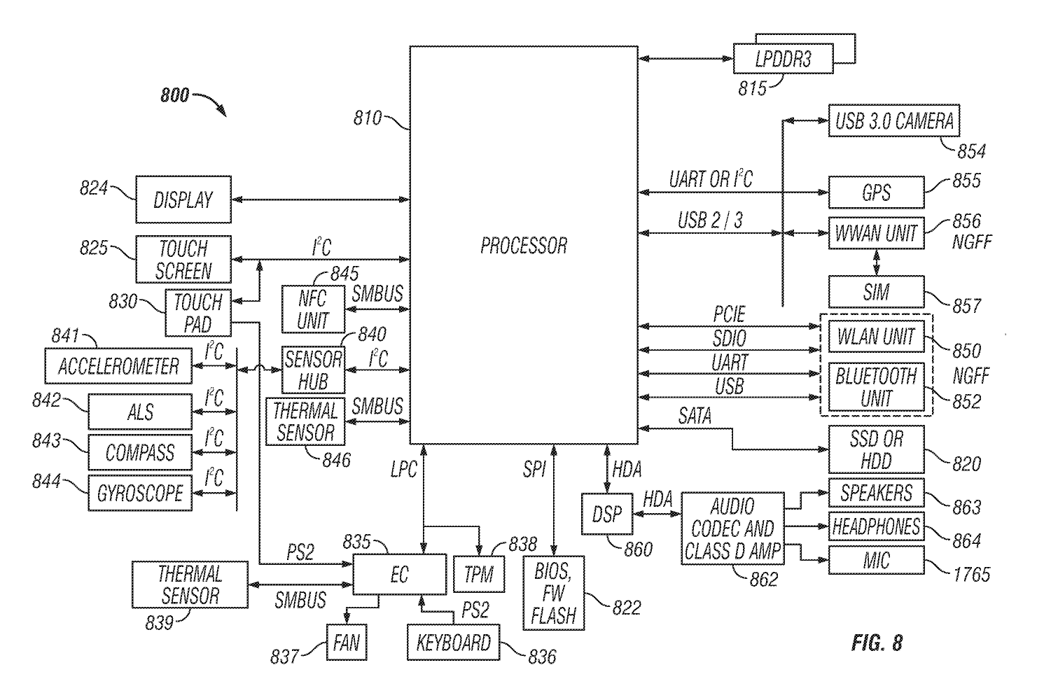

FIG. 8 is a block diagram of an electronic device 800 for utilizing a processor 810, in accordance with embodiments of the present disclosure. Electronic device 800 may include, for example, a notebook, an ultrabook, a computer, a tower server, a rack server, a blade server, a laptop, a desktop, a tablet, a mobile device, a phone, an embedded computer, or any other suitable electronic device.

Electronic device 800 may include processor 810 communicatively coupled to any suitable number or kind of components, peripherals, modules, or devices. Such coupling may be accomplished by any suitable kind of bus or interface, such as I²C bus, System Management Bus (SMBus), Low Pin Count (LPC) bus, SPI, High Definition Audio (HDA) bus, Serial Advance Technology Attachment (SATA) bus, USB bus (versions 1, 2, 3), or Universal Asynchronous Receiver/Transmitter (UART) bus.

Such components may include, for example, a display 824, a touch screen 825, a touch pad 830, a Near Field Communications (NFC) unit 845, a sensor hub 840, a thermal sensor 846, an Express Chipset (EC) 835, a Trusted Platform Module (TPM) 838, BIOS/firmware/flash memory 822, a DSP 860, a drive 820 such as a Solid State Disk (SSD) or a Hard Disk Drive (HDD), a wireless local area network (WLAN) unit 850, a Bluetooth unit 852, a Wireless Wide Area Network (WWAN) unit 856, a Global Positioning System (GPS), a camera 854 such as a USB 3.0 camera, or a Low Power Double Data Rate (LPDDR) memory unit 815 implemented in, for example, the LPDDR3 standard. These components may each be implemented in any suitable manner.

Furthermore, in various embodiments other components may be communicatively coupled to processor 810 through the components discussed above. For example, an accelerometer 841, Ambient Light Sensor (ALS) 842, compass 843, and gyroscope 844 may be communicatively coupled to sensor hub 840. A thermal sensor 839, fan 837, keyboard 846, and touch pad 830 may be communicatively coupled to EC 835. Speaker 863, headphones 864, and a microphone 865 may be communicatively coupled to an audio unit 864, which may in turn be communicatively coupled to DSP 860. Audio unit 864 may include, for example, an audio codec and a class D amplifier. A SIM card 857 may be communicatively coupled to WWAN unit 856. Components such as WLAN unit 850 and Bluetooth unit 852, as well as WWAN unit 856 may be implemented in a Next Generation Form Factor (NGFF).

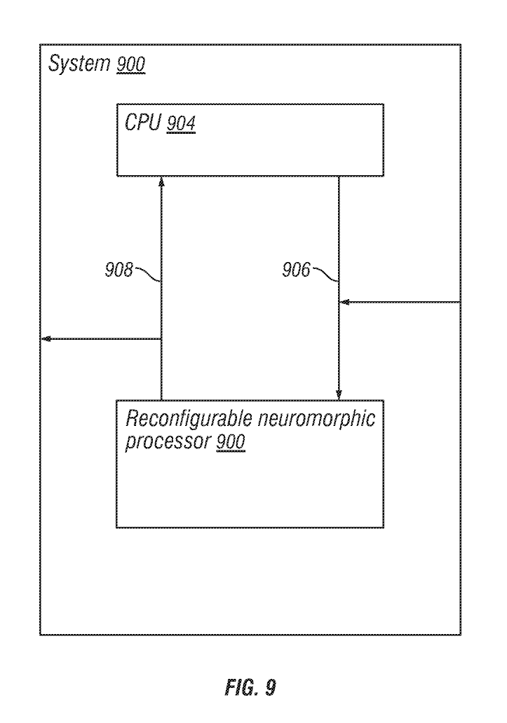

FIG. 9 is a block diagram of a system 900 including a neuromorphic processor, in accordance with embodiments of the present disclosure. System 900 may include, for example, a notebook, an ultrabook, a computer, a tower server, a rack server, a blade server, a laptop, a desktop, a tablet, a mobile device, a phone, an embedded computer, or any other suitable electronic device. System 900 may include CPU 904 communicatively coupled to any suitable number or kind of components, peripherals, modules, or devices. Such coupling may be accomplished by any suitable kind of bus or interface, such as I²C bus, System Management Bus (SMBus), Low Pin Count (LPC) bus, SPI, High Definition Audio (HDA) bus, Serial Advance Technology Attachment (SATA) bus, USB bus (versions 1, 2, 3), or Universal Asynchronous Receiver/Transmitter (UART) bus.

System 900 may further include neuromorphic processor 902. Neuromorphic processor 902 may be used (alone or in conjunction with another type of processor) to estimate or approximate functions that can depend on a large number of inputs and are generally unknown. For example, neuromorphic processor 902 may allow systems to perform facial recognition, to extract information from large data sets, and to perform object detection tasks that may be beyond of the scope of traditionally programmed solutions. Neuromorphic processor 902 may provide a path to computational intelligence by allowing machines to learn features from training data, when programming features in explicitly becomes too complex. Neuromorphic processor 902 and components thereof may be implemented using circuitry or logic.

Neuromorphic processor 902 may operate in a manner similar to biological neural networks (such as a central nervous system of an animal). Neuromorphic processor 902 may include one or more inputs 906 and one or more outputs 908. Inputs 906 may include circuitry or logic to accept input of digital data. Inputs 906 may be coupled to CPU 904, or may be connected to another component or peripheral component of system 900. Outputs 908 may include circuitry or logic to output digital data from neuromorphic processor 902. Outputs 908 may be coupled to CPU 904, or may be connected to another component or peripheral component of system 900.

System 900 may also include CPU 904. In one embodiment, neuromorphic processor 902 may be located on the same chip, die, or within the same package as CPU 904, which operates in conjunction with a neuromorphic processor. In other embodiments, a neuromorphic processor of the present disclosure may be located in a standalone chip, die, or within a different package as CPU 904 that operates in conjunction with neuromorphic processor 902.

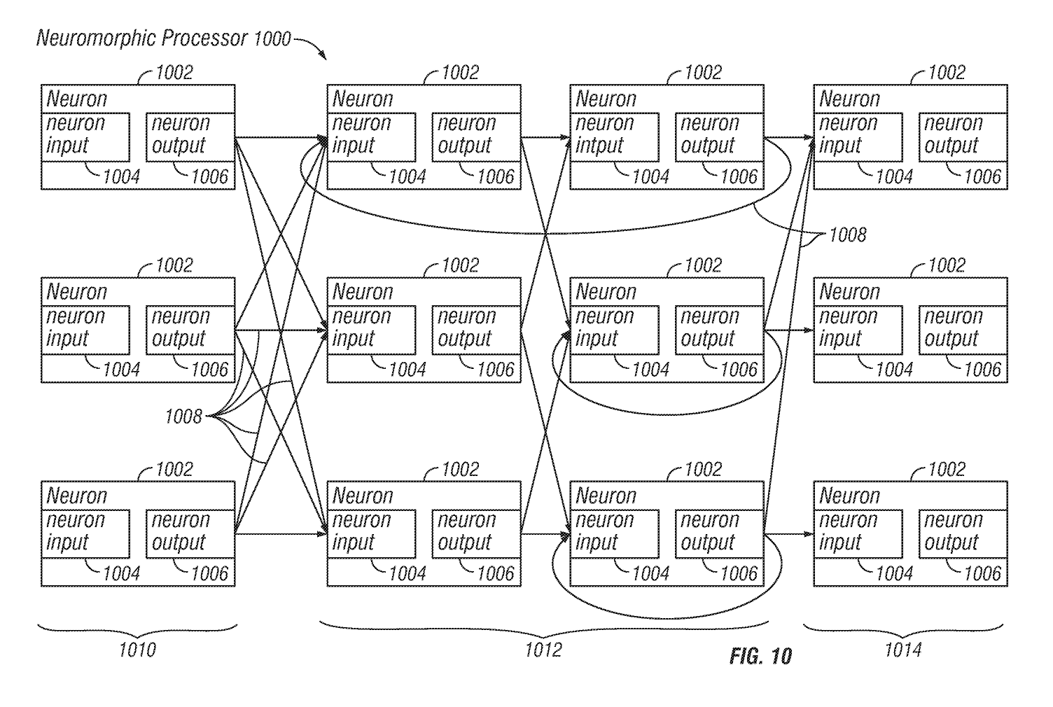

FIG. 10 is a block diagram of an example embodiment of a neuromorphic processor, in accordance with embodiments of the present disclosure. Neuromorphic processor 1000 may receive one or more inputs from sources external to neuromorphic processor 1000. These inputs may be transmitted to one or more neurons 1002 within neuromorphic processor 1000. Neurons 1002 and components thereof may be implemented using circuitry or logic. Typically, a neuromorphic processor may include thousands or millions of instances of neurons 1002, but any suitable number of neurons may be used. Each instance of neuron 1002 may include neuron input 1004 and neuron output 1006. Neurons 1002 may generate outputs that may be transmitted to inputs of other instances of neurons 1002. For example, neuron inputs 1004 and neuron outputs 1006 may be interconnected via synapses 1008.

Neurons 1002 and synapses 1008 may be interconnected such that neuromorphic processor 1000 operates to process or analyze information received by neuromorphic processor. In general, neurons 1002 may transmit an output pulse (or “fire” o “spike”) when inputs received through neuron input 1004 exceed a threshold. In some embodiments, neurons 1002 may sum or integrate signals received at neuron inputs 1004. For example, neurons 1002 may be implemented as leaky integrate-and-fire neuron. When this sum (referred to as a “membrane potential”) exceeds a threshold value, a neuron may generate an output (or “fire”) using a transfer function such as a sigmoid or threshold function. A leaky integrate and fire neuron may sum signals received at neuron inputs 1004 into a membrane potential and may also apply a decay factor (or leak) to reduce a membrane potential. Therefore a leaky integrate and fire neuron may fire only if multiple input signals are received at neuron inputs 1004 rapidly enough to exceed a threshold value (i.e. before a membrane potential decays too low to fire). In some embodiments, neurons 1002 may be implemented using circuits or logic that receive inputs, integrate inputs into a membrane potential, and decay a membrane potential. In further embodiments, inputs may be averaged, or any other suitable transfer function may be used. Furthermore, neurons 1002 may include comparator circuits or logic that generate an output spike at neuron output 1006 when the result of applying a transfer function to neuron input 1004 exceeds a threshold. Once neuron 1002 fires, it may disregard previously received input information by, for example, resetting a membrane potential to 0 or another suitable default value. Once the membrane potential is reset to 0, neuron 1002 may resume normal operation after a suitable period of time (or refractory period).”

Neurons 1002 may be interconnected through synapses 1008. Synapses 1008 may operate to transmit signals from an output of a first neuron 1002 to an input of a second neuron 1002. Neurons 1002 may transmit information over more than one instance of synapse 1008. In some embodiments, one or more instances of neuron output 1006 may be connected, via an instance of synapse 1008, to an instance of neuron input 1004 in the same neuron 1002. An instance of neuron 1002 generating an output to be transmitted over an instance of synapse 1008 may be referred to as a “pre-synaptic neuron” with respect to that instance of synapse 1008. An instance of neuron 1002 receiving an input transmitted over an instance of synapse 1008 may be referred to as a “post-synaptic neuron” with respect to that instance of synapse 1008. Because an instance of neuron 1002 may receive inputs from one or more instances of synapse 1008, and may also transmit outputs over one or more instances of synapse 1008, a single instance of neuron 1002 may therefore be both a “pre-synaptic neuron” and “post-synaptic neuron,” with respect to various instances of synapses 1008.

In some embodiments, neurons may be organized into one or more layers. Each instance of neuron 1002 may have one neuron output 1006 that may fan out through one or more synapses 1008 to one or more neuron inputs 1004. In some embodiments, neuron outputs 1006 of neurons 1002 in a first layer 1010 may be connected to neuron inputs 1004 of neurons 1002 in a second layer 1012. Such a layer 1010 may be referred to as a “feed-forward” layer. In some embodiments, each instance of neuron 1002 in an instance of layer 1010 may fan out to each instance of neuron 1002 in a second layer 1012. Such a layer 1010 may be referred to as a fully connected feed-forward layer. In some embodiments, each instance of neuron 1002 in an instance of layer 1012 may fan out to fewer than all instances of neuron 1002 in a second layer 1014. Such a layer 1012 may be referred to as a sparsely connected feed-forward layer. In some embodiments, neurons 1002 in first layer 1012 may fan out to neurons 1002 in multiple other layers, including to neurons 1002 in the same layer 1012. Such a layer 1012 may be referred to as a “recurrent” layer. Neuromorphic processor 1000 may include any suitable combination of recurrent layers and feed forward layers, including both sparse and fully connected feed forward layers.

Neuromorphic processor 1000 may include a reconfigurable interconnect architecture or dedicated hard-wired interconnects to connect synapse 1008 to neurons 1002. Neuromorphic processor 1000 may include circuitry or logic that allows synapses to be allocated to different neurons as needed based on the neural network topology and neuron fan-in/out. For example, synapses 1008 may be connected to neurons 1002 using an interconnect fabric, such as network-on-chip, or with dedicated connections. Synapse interconnections and components thereof may be implemented using circuitry or logic.

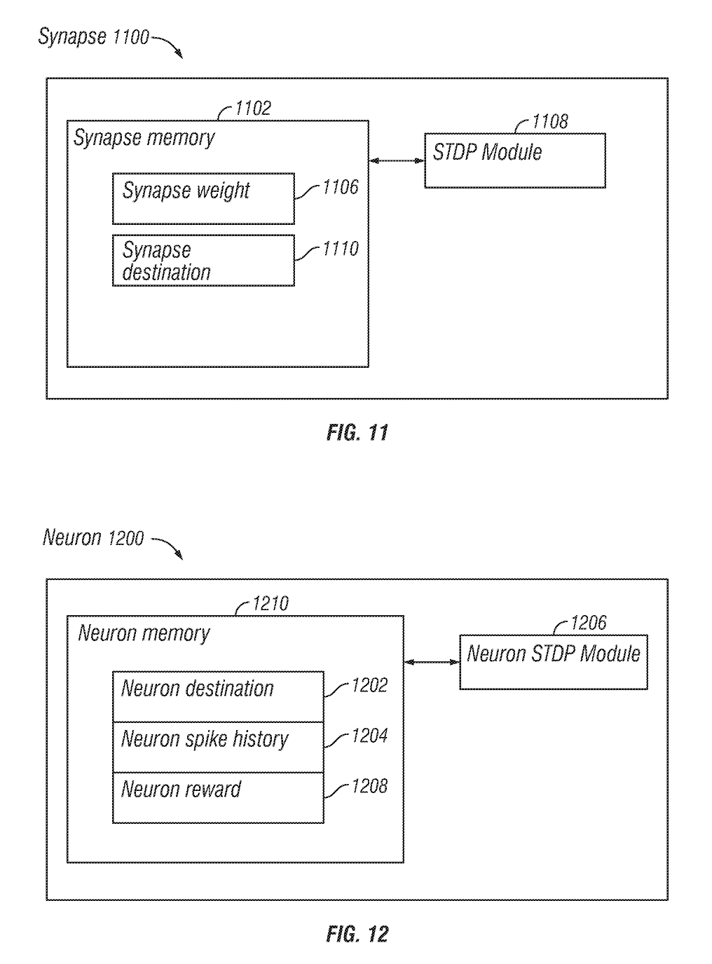

FIG. 11 is a block diagram of a synapse, in accordance with embodiments of the present disclosure. Synapse 1100 and components thereof may be implemented using circuitry or logic. Each synapse 1100 may include synapse memory 1102. Synapse memory 1102 may be composed of static random access memory, memristors, spin torque memory, or any other suitable type of memory circuit or logic. Synapse memory 1102 may store synapse weight 1106 and synapse destination 1110. Synapse weight 1106 may include a digital representation of a weight to be transmitted to the neuron identified in synapse destination 1110. For example, synapse weight 1106 may include a binary value of between 2 and 32 bits. Synapse destination 1110 may include a digital representation identifying a neuron to which information stored in a particular instance of synapse memory 1102 should be transmitted.

Synapses 1100 may have an associated synapse weight. When synapses 1106 transmit an output of an instance of neuron to an input of an instance of neuron, that output may be multiplied by a synapse weight. As previously described, a neuron may sum or integrate these values. During operation, synapse weights 1106 of synapses 1100 may be selected, modified, or adjusted, making a neuromorphic processor adaptive to various inputs and capable of learning. The process of selecting, modifying, or adjusting a synapse weight may be referred to as training. One method of training synapse weights may be spike timing dependent plasticity (“STDP”). STDP may be a temporally asymmetric form of Hebbian learning induced by temporal correlations between the spikes of pre- and postsynaptic neurons. Accordingly, a neuromorphic processor may be a learning architecture that may be trained through iterative adjustment of synapse weights. STDP may modify synapse weights according to a relative spike timing between the pre-synaptic neurons and post-synaptic neurons that each synapse connects. A pre-synaptic neuron firing may have a certain probability of inducing firing in a post-synaptic neuron. Accordingly, when a pre-synaptic neurons fires before a post-synaptic neurons fires, there may be a probability of causation or correlation between a pre-synaptic neuron firing and inducing firing in a post-synaptic neuron. This relationship may be reinforced by adjusting the synapse weight connecting the two neurons through long-term potentiation (LTP). LTP may increase synapse weights where the relative timing of pre-synaptic neuron firing and firing in a post-synaptic neuron indicates a correlation or causation. Relatedly, when a pre-synaptic neurons fires after a post-synaptic neurons fires, there may not be a probability of causation or correlation between a pre-synaptic neuron firing and inducing firing in a post-synaptic neuron. Accordingly, long-term depression (LTD) may be used to decrease a synapse weight value where the relative timing of pre-synaptic neuron firing and firing in a post-synaptic neuron indicates a lack of correlation or causation. LTD weakens synaptic connections that are not related to the training dataset and prevents runaway potentiation or weight saturation.

STDP module 1108 may operate to adjust synapse weights 1106. STDP module 1108 may receive packets from a pre-synaptic neuron or a post-synaptic neuron of synapse 1100. STDP module 1108 may parse these packets to identify instructions for adjusting synapse weight 1106. For example, synapse weight 1106 may be incremented or decremented by one. A positive or negative offset may be added to synapse weight 1106. The sign of synapse weight 1106 may be altered, or the synapse weight 1106 may be multiplied or otherwise scaled. STDP module 1108 and components thereof may be implemented using circuitry or logic.

FIG. 12 is a block diagram of a neuron, in accordance with embodiments of the present disclosure. Each instance of neuron 1200 may include a neuron memory. Neuron memory may be composed of register files, static random access memory, memristors, spin torque memory, or any other suitable type of memory circuit or logic. Neuron memory may include circuitry or logic that can store information relating to the operation of neuron 1200. For example, neuron memory may store one or more neuron destinations 1202, and neuron spike history 1204. A neuron destination may include a digital address indicating an identity of a synapse to receive an input from a particular instance of neuron 1200. Initial neuron destinations may be written in neuron memory during setup or training of a neuromorphic processor. Neuron destinations may be determined based upon a task to be performed by a neuromorphic processor. In some embodiments, a processer, such as CPU 904, may initialize a neuromorphic processor by writing initial neuron destinations in neuron memory 1210.

Neuron spike history 1204 may describe how recently neuron 1200 has fired. For example, neuron spike history 1204 may include an integer, or binary coded number. In some embodiments, when neuron 1200 fires, neuron spike history 1204 may be written with a maximum value storable in neuron spike history 1204. In some embodiments, a maximum value may include a largest storable value in a portion of neuron memory 1210 allocated to store neuron spike history 1204, or may include any suitable threshold value. On each subsequent operation period where neuron 1200 does not spike, neuron spike history 1204 may decrement by a fixed value. For example, neuron spike history 1204 may decrement by one. When neuron spike history 1204 reaches 0, neuron spike history 1204 may stop decrementing. Therefore, the more recently that neuron 1200 has fired, the larger the value in neuron spike history module 1204.

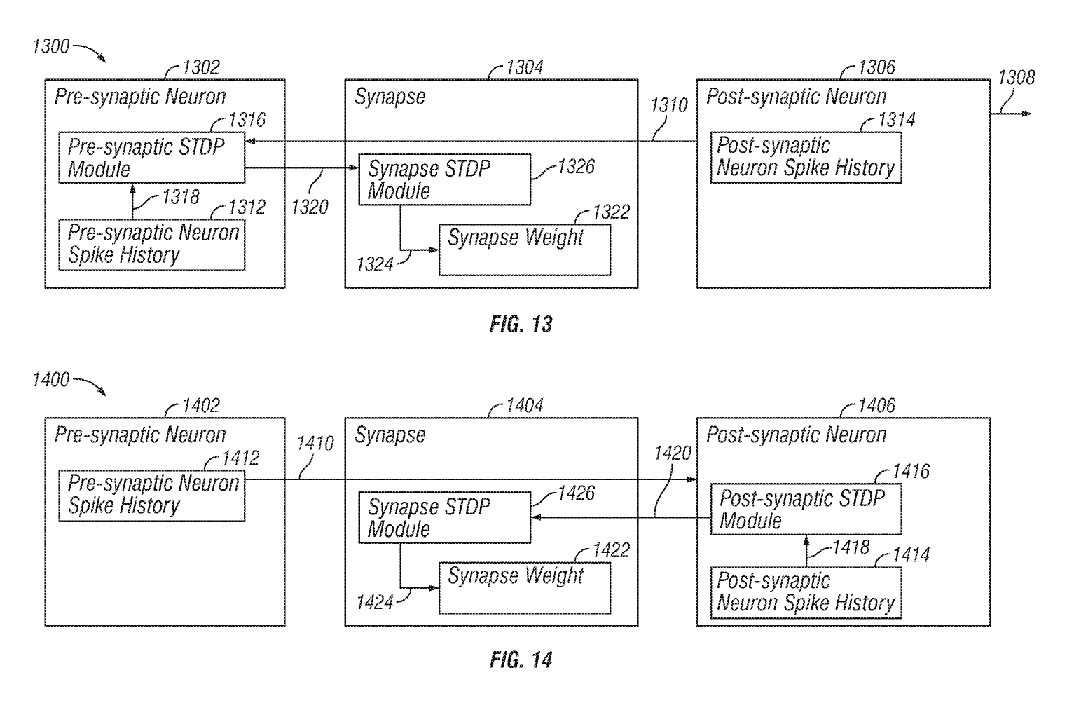

FIG. 13 is an operational block diagram of long term potentiation in a neuromorphic processor, in accordance with embodiments of the present disclosure. Although operational diagram 1300 describes operation of particular elements, operational diagram 1300 may be performed by any suitable combination or type of elements. For example, operational diagram 1300 may be implemented by the elements illustrated in FIGS. 1-12 or any other suitable system. As such, the preferred initialization point for operational diagram 1300 and the order of the elements comprising operational diagram 1300 may depend on the implementation chosen. In some embodiments, some elements may be optionally omitted, reorganized, repeated, or combined. Moreover, portions of operational diagram 1300 may be executed in parallel within itself.

At 1310, in one embodiment, post-synaptic neuron 1306 may spike. In response to post-synaptic neuron 1306 spiking, post-synaptic neuron spike history 1314 may be written with a maximum value. Furthermore, in addition to transmitting a forward propagating signal through synapses 1308 to other neurons, post-synaptic neuron 1306 may transmit a backward propagating signal to input synapses and neuron, such as synapse 1304 and pre-synaptic neuron 1302. Specifically, a backward propagating signal may be transmitted to pre-synaptic STDP module 1316. The backward propagating signal may be transmitted via a multicast network on chip, through synapse 1304, or through any other suitable method. A backward propagating signal may not be evaluated as an input to pre-synaptic neuron 1304. A backward propagating signal may include a signal indicating that post-synaptic neuron 1306 has fired. For example, a backward propagating signal may include an instruction, packet, or other signal indicating that post-synaptic neuron 1306 has fired. Additionally, a backward propagating signal may include a spike history value of post-synaptic neuron 1306, such as post-synaptic neuron spike history 1314.

At 1318, in one embodiment, pre-synaptic STDP module 1316 may retrieve pre-synaptic neuron spike history 1312. Pre-synaptic STDP module 1316 may compare and process pre-synaptic neuron spike history 1312 and post-synaptic neuron spike history 1314. In some embodiments, pre-synaptic STDP module 1316 may receive post-synaptic neuron spike history 1314 from post-synaptic neuron 1306. In further embodiments, pre-synaptic STDP module 1316 may determine a value of post-synaptic neuron spike history 1314 based on receiving a signal indicating that indicating that post-synaptic neuron 1306 has fired. For example, pre-synaptic STDP module 1316 may determine that post-synaptic neuron spike history 1314 has been set to its maximum value based on receiving an signal indicating that post-synaptic neuron 1306 has fired. If both pre-synaptic neuron spike history 1312 and post-synaptic neuron spike history 1314 are positive and non-zero, pre-synaptic STDP module 1316 may subtract pre-synaptic neuron spike history 1312 from post-synaptic neuron spike history 1314. The resultant of this operation may be referred to as a synapse weight offset. If either pre-synaptic neuron spike history 1312 or post-synaptic neuron spike history 1314 are equal to zero, synapse weight offset of 0 may be assigned.

At 1320, in one embodiment, pre-synaptic STDP module 1316 may adjust synapse weight 1322 by adding a synapse weight offset. After calculating a synapse weight offset, pre-synaptic STDP module 1316 may transmit a synapse weight offset to synapse 1304. Synapse 1304 may include synapse STDP module 1326. Synapse STDP module 1326 may retrieve synapse weight 1322. Synapse STDP module 1326 may calculate an updated synapse weight by adding a synapse weight offset to synapse weight 1322. In some embodiments, a synapse weight offset may be additionally modified by applying any suitable transfer function.

At 1324, in one embodiment, synapse STDP module 1326 may then overwrite synapse weight 1322 with an updated synapse weight.

FIG. 14 is an operational block diagram of long term depression in a neuromorphic processor, in accordance with embodiments of the present disclosure. Although operational diagram 1400 describes operation of particular elements, operational diagram 1400 may be performed by any suitable combination or type of elements. For example, operational diagram 1400 may be implemented by the elements illustrated in FIGS. 1-13 or any other suitable system. As such, the preferred initialization point for operational diagram 1400 and the order of the elements comprising operational diagram 1400 may depend on the implementation chosen. In some embodiments, some elements may be optionally omitted, reorganized, repeated, or combined. Moreover, portions of operational diagram 1400 may be executed in parallel within itself.

At 1410, in one embodiment, pre-synaptic neuron 1402 may spike. In response to pre-synaptic neuron 1402 spiking, pre-synaptic neuron spike history 1412 may be written with a maximum value. Furthermore, in addition to transmitting a forward propagating signal through synapses 1404 to other neurons, pre-synaptic neuron 1402 may transmit a forward propagating STDP signal to synapses and neuron, such as synapse 1404 and post-synaptic neuron 1406. Specifically, a forward propagating signal may be transmitted to post-synaptic STDP module 1406. The forward propagating signal may be transmitted via a multicast network on chip, through synapse 1404, or through any other suitable method. A forward propagating STDP signal may not be evaluated as an input to post-synaptic neuron 1406. A forward propagating STDP signal may include a signal indicating that pre-synaptic neuron 1402 has fired. For example, a forward propagating signal may include an instruction, packet, or other signal indicating that pre-synaptic neuron 1402 has fired. Additionally, a forward propagating signal may include a spike history value of pre-synaptic neuron 1402, such as post-synaptic neuron spike history 1412.

At 1418, in one embodiment, post-synaptic STDP module 1416 may retrieve post-synaptic neuron spike history 1414. Post-synaptic STDP module 1416 may compare and process pre-synaptic neuron spike history 1412 and post-synaptic neuron spike history 1414. In some embodiments, post-synaptic STDP module 1416 may receive pre-synaptic neuron spike history 1412 from pre-synaptic neuron 1402. In further embodiments, post-synaptic STDP module 1416 may determine a value of pre-synaptic neuron spike history 1412 based on receiving a signal indicating that indicating that pre-synaptic neuron 1402 has fired. For example, post-synaptic STDP module 1416 may determine that pre-synaptic neuron spike history 1412 has been set to its maximum value based on receiving an signal indicating that pre-synaptic neuron 1402 has fired. For example, if both pre-synaptic neuron spike history 1412 and post-synaptic neuron spike history 1414 are positive and non-zero, post-synaptic STDP module 1416 may subtract post-synaptic neuron spike history 1414 from pre-synaptic neuron spike history 1412. The resultant of this operation may be referred to as a synapse weight offset. If either pre-synaptic neuron spike history 1412 or post-synaptic neuron spike history 1414 are equal to zero, synapse weight offset of 0 may be assigned. In some embodiments, a synapse weight offset may be additionally modified by applying any suitable transfer function.

At 1420, in one embodiment, post-synaptic STDP module 1416 may adjust synapse weight 1422 by adding a synapse weight offset. After calculating a synapse weight offset, post-synaptic STDP module 1416 may transmit a synapse weight offset to synapse 1404. Synapse 1404 may include synapse STDP module 1426. Synapse STDP module 1426 may retrieve synapse weight 1422. Synapse STDP module 1426 may calculate an updated synapse weight by adding a synapse weight offset to synapse weight 1422.

At 1424, in one embodiment, synapse STDP module 1426 may then overwrite synapse weight 1422 with an updated synapse weight.

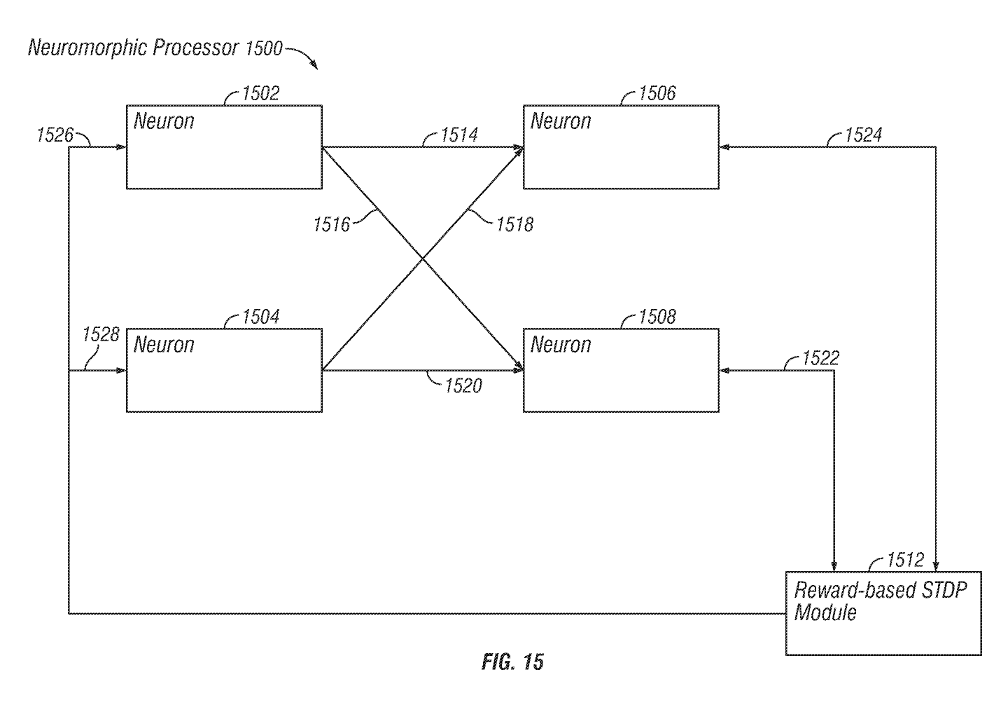

FIG. 15 is a block diagram of a neuromorphic processor operable to perform reward-based STDP, in accordance with embodiments of the present disclosure. In some embodiments, STDP may be used during training of a neuromorphic processor. For example, the operation of LTP and LTD may be modified using a reward-based system. In some embodiments, a neuromorphic processor may be trained by applying a set of known inputs. Reward modulated STDP may use a supervised teacher signal and spike information from neurons to perform training. In general, reward-modulated STDP operates by providing pre-determined inputs to a neuromorphic processor, monitoring outputs of a neuromorphic processor, and reinforcing synapses (by increasing synapse weight) that cause correct outputs and minimizing synapses (by decreasing synapse weight) that cause incorrect outputs. Reward-modulated STDP may therefore be implemented using circuitry or logic, such as counters and buffers, resulting in a hardware friendly implementation.

Neuromorphic processor 1500 may include neurons 1502, 1504, 1506 and 1508 and synapses 1514, 1516, 1518, and 1520. Synapses 1514, 1516, 1518, and 1520 may interconnect neurons 1502, 1504, 1506 and 1508 and may transmit signals indicating that a pre-synaptic neuron has spiked. For example, neuron 1502 may be a pre-synaptic neuron with respect to synapse 1514, while neuron 1506 may be a post-synaptic neuron with respect to synapse 1514. Synapses 1514, 1516, 1518, and 1520 may include a synapse weight, and may transmit this synapse weight to a post-synaptic neuron.

As described above with reference to FIG. 10, a neuromorphic processor may include one or more input neurons. For example, neurons 1502 and 1504 of neuromorphic processor 1500 may be input neurons. Similarly, a neuromorphic processor may include one or more output neurons. For example, neurons 1506 and 1508 of neuromorphic processor 1500 may be output neurons. Neuromorphic processor 1500 may also include reward-modulated STDP module 1512. In some embodiments, reward-modulated STDP module 1512 may provide input signals 1526 and 1528 to input neurons 1502 and 1504, respectively. In some embodiments, provided input signals 1526 and 1528 may be transmitted to input neurons 1502 and 1504 from any other suitable source. In embodiments where input signals 1526 and 1528 are transmitted to input neurons 1502 and 1504 from a source other than reward-modulated STDP module 1512, reward-modulated STDP module 1512 may monitor input signals 1526 and 1528 or to otherwise ascertain input signals 1526 and 1528. Neuromorphic processor 1500 may be operable to analyze and process input signals 1526 and 1528. Input signals 1526 and 1528 may correspond to any suitable input information. Input signals 1526 and 1528 may be selected so that an ideal output response from neuromorphic processor 1500 may be predicted, estimate, or calculated. For example, in the case of a neuromorphic processor operable to recognize handwritten letters from input images, input signals may be selected to correspond to an image of a particular letter. In such an example, a neuromorphic processor would be expected to successfully recognize a letter and outputs of neuromorphic processor would be expected to correspond to identification of that letter.

Reward-modulated STDP module 1512 may generate teacher signals 1524 and 1522, which may be transmitted to output neurons 1506 and 1508. Teacher signals 1524 and 1522 may be used to modify synapse weights. Teacher signals 1524 and 1522 may include a signed multiplier. A signed multiplier may include a signed integer or any other suitable value. A sign of a signed multiplier in teacher signals 1524 and 1522 may depend on an expected output of neuromorphic processor 1500. For example, if, based on input signals 1526 and 1528, neuron 1506 should fire, teacher signal 1524 may include a positive multiplier, such as +1. For example, if, based on input signals 1526 and 1528, neuron 1508 should not fire, teacher signal 1522 may include a non-positive multiplier, such as 0 or −1. Output neurons 1506 and 1508 may receive and store teacher signals 1524 and 1522. For example, output neuron 1506 may store teacher signal 1524 in a neuron memory as a neuron reward, such as neuron reward 1208 in neuron memory 1210, described above with reference to FIG. 12.

When output neurons 1506 and 1508 fire, reward-based long term potentiation may be performed. The process of long term potentiation is described above with reference to FIG. 13. Reward-based long term potentiation may include performance of similar operations. For example, when output neuron 1506 fires, output neuron 1506 may transmit a signal indicating that output neuron 1506 has fired to pre-synaptic neuron 1502. In addition to a signal indicating that output neuron 1506 has fired, output neuron 1506 may also transmit a post-synaptic neuron reward to pre-synaptic neuron 1502. Because, in this example, output neuron 1506 is expected to fire based on input signals 1526 and 1528, post-synaptic neuron reward may have a positive value. In long term potentiation, pre-synaptic neuron 1502 may calculate a synapse weight offset to be transmitted to synapse 1514. In reward-based long term potentiation, before transmitting a synapse weight offset to synapse 1514, pre-synaptic neuron 1502 may multiply a synapse weight offset by a neuron reward value. Multiplication of a synapse weight offset by a neuron reward value may change the sign of a synapse weight offset. Reward-based long term potentiation may also be performed between output neuron 1506 and input neuron 1504.

Similarly, when output neurons 1506 and 1508 fire, reward-based long term depression may be performed. Long term depression is described above with reference to FIG. 14. Reward-based long term depression may include performance of similar operations. For example, when input neuron 1504 fires, input neuron 1504 may transmit a signal indicating that input neuron 1504 has fired to post-synaptic neuron 1508. Post-synaptic neuron 1508 may calculate a synapse weight offset to be transmitted to synapse 1520. In reward-based long term depression, before transmitting a synapse weight offset to synapse 1520, post-synaptic neuron 1508 may retrieve a neuron reward value from a neuron memory. Post-synaptic neuron 1508 may multiply a synapse weight offset by a neuron reward value. Because, in this example, output neuron 1508 is not expected to fire based on input signals 1526 and 1528, post-synaptic neuron reward may have a zero or negative value. Multiplication of a synapse weight offset by a neuron reward value may change the sign of a synapse weight offset.

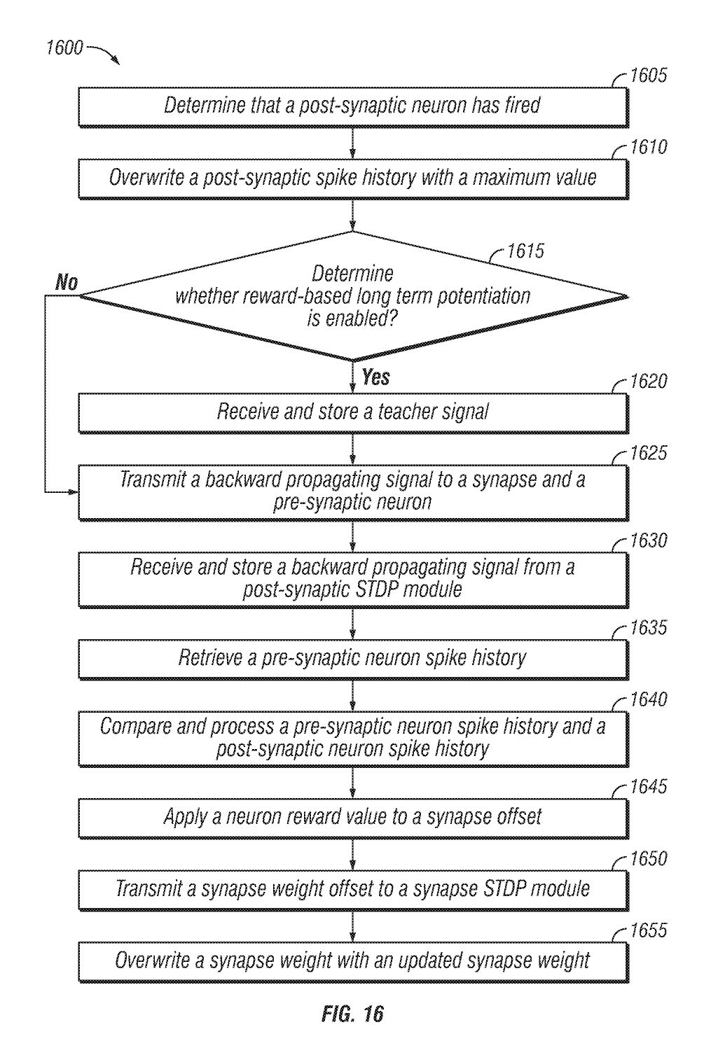

FIG. 16 is a flow chart of a method 1600 for performing long term potentiation in a neuromorphic processor, in accordance with embodiments of the present disclosure. Although method 1600 describes operation of particular elements, method 1600 may be performed by any suitable combination or type of elements. For example, method 1600 may be implemented by the elements illustrated in FIGS. 1-15 or any other system operable to implement method 1600. As such, the preferred initialization point for method 1600 and the order of the elements comprising method 1600 may depend on the implementation chosen. In some embodiments, some elements may be optionally omitted, reorganized, repeated, or combined. Moreover, portions of method 1600 may be executed in parallel within itself.

At 1605, in one embodiment a post-synaptic STDP module may determine that a post-synaptic neuron has fired. For example, a post-synaptic STDP module may receive a signal indicating that a post-synaptic neuron has fired.

At 1610, in one embodiment a post-synaptic STDP module may overwrite a post-synaptic spike history with a maximum value. In response to a post-synaptic neuron firing, a post-synaptic neuron spike history may be written with a maximum value. For example, a post-synaptic STDP module may overwrite a post-synaptic neuron spike history stored in a neuron memory. A neuron memory may include an allocated memory location for storing a post-synaptic neuron spike history. A post-synaptic STDP module may overwrite a previously stored value with the largest value storable in an allocated memory location in a neuron memory. Alternatively, a maximum value may include any other suitable predefined value.

At 1615, in one embodiment a post-synaptic STDP module may determine whether reward-based long term potentiation is enabled. For example, a post-synaptic STDP module may determine whether a post-synaptic neuron is an output neuron. A post-synaptic STDP module may additionally read a neuron memory to determine whether a reward value is stored in neuron memory. If reward-based long term potentiation is enabled, method 1600 may proceed to 1620. Otherwise, method 1600 may proceed to 1625.

At 1620, in one embodiment a post-synaptic STDP module of an output neuron may receive and store a teacher signal. A teacher signal may be used to modify synapse weights. Teacher signals may include a signed multiplier. A signed multiplier may include a signed integer or any other suitable value. A sign of a signed multiplier in teacher signals may depend on an expected output of a neuromorphic processor. For example, if, based on an input signal, a post-synaptic neuron should fire, a teacher signal may include a positive multiplier, such as +1. Furthermore, if, based on an input signal, a post-synaptic neuron should not fire, a teacher signal may include a non-positive multiplier, such as 0 or −1. Output neurons may receive and store teacher signals in neuron memory.

At 1625, in one embodiment a post-synaptic STDP module may transmit a backward propagating signal to a synapse and a pre-synaptic neuron. Specifically, a backward propagating signal may be transmitted to a pre-synaptic STDP module. A backward propagating signal may be transmitted via a multicast network on chip, through a synapse, or through any other suitable method. A backward propagating signal may not be evaluated as an input to pre-synaptic neuron. A backward propagating signal may include a signal indicating that the post-synaptic neuron has fired. For example, backward propagating signal may include a spike history value of a post-synaptic neuron, such as post-synaptic neuron spike history. If, at 1615, it was determined that reward-based long term potentiation is enabled, a backward propagating signal may additionally include a neuron reward value.

At 1630, in one embodiment, a pre-synaptic STDP module may receive and store a backward propagating signal from a post-synaptic STDP module. For example, a pre-synaptic STDP module may store a backward propagating signal in a pre-synaptic neuron memory. A backward propagating signal may include a signal indicating that the post-synaptic neuron has fired. For example, backward propagating signal may include a spike history value of a post-synaptic neuron, such as post-synaptic neuron spike history. If at 1615, it was determined that reward-based long term potentiation is enabled, a backward propagating signal may additionally include a neuron reward value.

At 1635, in one embodiment, a pre-synaptic STDP module may retrieve a pre-synaptic neuron spike history. A pre-synaptic spike history may describe how recently a pre-synaptic neuron has fired. A pre-synaptic spike history may be stored in a pre-synaptic neuron memory.

At 1640, in one embodiment, a pre-synaptic STDP module may compare and process a pre-synaptic neuron spike history and a post-synaptic neuron spike history. A pre-synaptic STDP module may determine a value of post-synaptic neuron spike history based on receiving a signal indicating that indicating that a post-synaptic neuron has fired. For example, a pre-synaptic STDP module may determine that post-synaptic neuron spike history has been set to its maximum value based on receiving an signal indicating that a post-synaptic neuron has fired. If both pre-synaptic neuron spike history and post-synaptic neuron spike history are positive and non-zero, a pre-synaptic STDP module may subtract a pre-synaptic neuron spike history from a post-synaptic neuron spike history. The resultant of this operation may be referred to as a synapse weight offset. If either pre-synaptic neuron spike history or post-synaptic neuron spike history are equal to zero, synapse weight offset of 0 may be assigned.

At 1645, in one embodiment, a pre-synaptic STDP module may apply a neuron reward value to a synapse offset. If at 1630, a pre-synaptic STDP module received a neuron reward value, a pre-synaptic STDP module may modify a synapse weight offset by multiplying a synapse weight offset by a neuron reward value.

At 1650, in one embodiment, a pre-synaptic STDP module may transmit a synapse weight offset to a synapse STDP module. Synapse may include a synapse STDP module. A synapse STDP module may receive a synapse weight offset from a pre-synaptic STDP module.

At 1655, in one embodiment, a synapse STDP module 1326 may overwrite a synapse weight with an updated synapse weight. Synapse STDP module may retrieve a synapse weight from a synapse memory. Synapse STDP module may calculate an updated synapse weight by adding a synapse weight offset to a synapse weight. In some embodiments, a synapse weight offset may be additionally modified by applying any suitable transfer function. Synapse STDP module may write an updated synapse weight into a synapse memory.

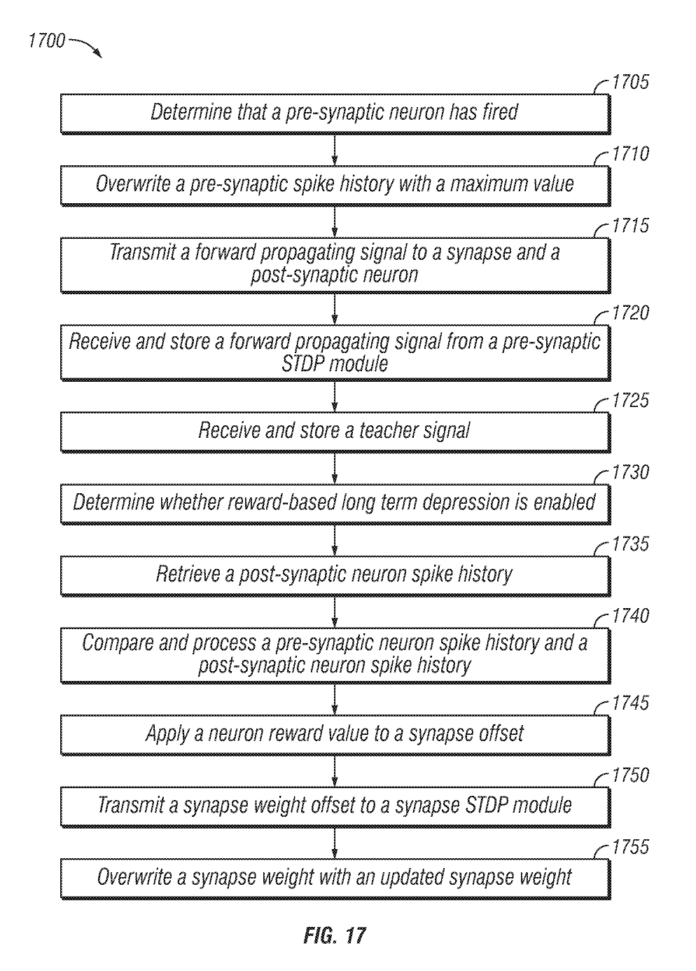

FIG. 17 is a flow chart of a method 1700 for performing long term depression in a neuromorphic processor, in accordance with embodiments of the present disclosure. Although Method 1700 describes operation of particular elements, method 1700 may be performed by any suitable combination or type of elements. For example, method 1700 may be implemented by the elements illustrated in FIGS. 1-15 or any other system operable to implement method 1700. As such, the preferred initialization point for method 1700 and the order of the elements comprising method 1700 may depend on the implementation chosen. In some embodiments, some elements may be optionally omitted, reorganized, repeated, or combined. Moreover, portions of method 1700 may be executed in parallel within itself.

At 1705, in one embodiment a pre-synaptic STDP module may determine that a pre-synaptic neuron has fired. For example, a pre-synaptic STDP module may receive a signal indicating that a pre-synaptic neuron has fired.

At 1710, in one embodiment a pre-synaptic STDP module may overwrite a pre-synaptic spike history with a maximum value. In response to a pre-synaptic neuron firing, a pre-synaptic neuron spike history may be written with a maximum value. For example, a pre-synaptic STDP module may overwrite a pre -synaptic neuron spike history stored in a neuron memory. A neuron memory may include an allocated memory location for storing a pre -synaptic neuron spike history. A pre-synaptic STDP module may overwrite a previously stored value with the largest value storable in an allocated memory location in a neuron memory. Alternatively, a maximum value may include any other suitable predefined value.

At 1715, in one embodiment a pre-synaptic STDP module may transmit a forward propagating signal to a synapse and a post-synaptic neuron. Specifically, a forward propagating signal may be transmitted to a post-synaptic STDP module. A forward propagating signal may be transmitted via a multicast network on chip, through a synapse, or through any other suitable method. A forward propagating signal may not be evaluated as an input to post-synaptic neuron. A forward propagating signal may include a signal indicating that a pre-synaptic neuron has fired.

At 1720, in one embodiment, a post-synaptic STDP module may receive and store a forward propagating signal from a pre-synaptic STDP module. For example, a post-synaptic STDP module may store a forward propagating signal in a post-synaptic neuron memory. A forward propagating signal may include a signal indicating that a pre-synaptic neuron has fired.

At 1725, in one embodiment a post-synaptic STDP module of an output neuron may receive and store a teacher signal. A teacher signal may be used to modify synapse weights. Teacher signals may include a signed multiplier. A signed multiplier may include a signed integer or any other suitable value. A sign of a signed multiplier in teacher signals may depend on an expected output of a neuromorphic processor. For example, if, based on an input signal, a post-synaptic neuron should fire, a teacher signal may include a positive multiplier, such as +1. Furthermore, if, based on an input signal, a post-synaptic neuron should not fire, a teacher signal may include a non-positive multiplier, such as 0 or −1. Output neurons may receive and store teacher signals in neuron memory.

At 1730, in one embodiment a post-synaptic STDP module may determine whether reward-based long term depression is enabled. For example, a post-synaptic STDP module may determine whether a post-synaptic neuron is an output neuron. A post-synaptic STDP module may additionally read a neuron memory to determine whether a reward value is stored in neuron memory.

At 1735, in one embodiment, a post-synaptic STDP module may retrieve a post-synaptic neuron spike history. A post-synaptic spike history may describe how recently a post-synaptic neuron has fired. A post-synaptic spike history may be stored in a post-synaptic neuron memory.

At 1740, in one embodiment, a post-synaptic STDP module may compare and process a pre-synaptic neuron spike history and a post-synaptic neuron spike history. A post-synaptic STDP module may determine a value of pre-synaptic neuron spike history based on receiving a signal indicating that indicating that a pre-synaptic neuron has fired. For example, a pre-synaptic STDP module may determine that pre-synaptic neuron spike history has been set to its maximum value based on receiving an signal indicating that a pre-synaptic neuron has fired. If both pre-synaptic neuron spike history and post-synaptic neuron spike history are positive and non-zero, a post-synaptic STDP module may subtract a post-synaptic neuron spike history from a pre-synaptic neuron spike history. The resultant of this operation may be referred to as a synapse weight offset. If either pre-synaptic neuron spike history or post-synaptic neuron spike history are equal to zero, synapse weight offset of 0 may be assigned.

At 1745, in one embodiment, a pre-synaptic STDP module may apply a neuron reward value to a synapse offset. If at 1730, a post-synaptic STDP module determined that reward-based long term depression is enabled, a post-synaptic STDP module may modify a synapse weight offset by multiplying a synapse weight offset by a neuron reward value.

At 1750, in one embodiment, a post-synaptic STDP module may transmit a synapse weight offset to a synapse STDP module. Synapse may include a synapse STDP module. A synapse STDP module may receive a synapse weight offset from a pre-synaptic STDP module.

At 1755, in one embodiment a synapse STDP module may overwrite synapse weight with an updated synapse weight. Synapse STDP module may retrieve a synapse weight from a synapse memory. Synapse STDP module may calculate an updated synapse weight by adding a synapse weight offset to a synapse weight. In some embodiments, a synapse weight offset may be additionally modified by applying any suitable transfer function. Synapse STDP module may write an updated synapse weight into a synapse memory.

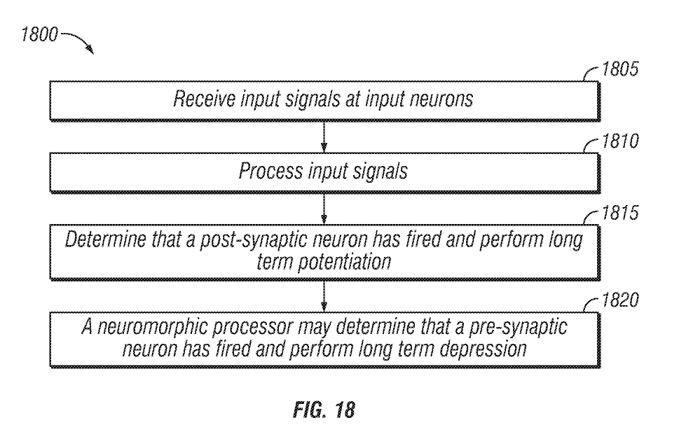

FIG. 18 is a flow chart of a method 1800 for performing event-based spike timing dependent plasticity (STDP) in a neuromorphic processor, in accordance with embodiments of the present disclosure. Although method 1800 describes operation of particular elements, method 1800 may be performed by any suitable combination or type of elements. For example, method 1800 may be implemented by the elements illustrated in FIGS. 1-17 or any other system operable to implement method 1800. As such, the preferred initialization point for method 1800 and the order of the elements comprising method 1800 may depend on the implementation chosen. In some embodiments, some elements may be optionally omitted, reorganized, repeated, or combined. Moreover, portions of method 1800 may be executed in parallel within itself

At 1805, in one embodiment, a neuromorphic processor may receive input signals at input neurons. For example, a neuromorphic processor may receive input signals from a source external to a neuromorphic processor. Furthermore, a neuromorphic processor may receive input signals from a reward-based STDP module.

At 1810, in one embodiment, a neuromorphic processor may process input signals. Neurons in a neuromorphic processor may receive and process input signals. Neurons may integrate or sum input signals into a membrane potential. When a membrane potential exceeds a threshold value, a neuron may fire. When a neuron fires, a neuron may transmit a signal through a synapse to another instance of a neuron, which may be referred to as a post-synaptic neuron.

At 1815, in one embodiment, a neuromorphic processor may determine that a post-synaptic neuron has fired and perform long term potentiation. For example, a neuromorphic processor may perform some or all of the steps of method 1600.

At 1820, in one embodiment, a neuromorphic processor may determine that a pre-synaptic neuron has fired and perform long term depression. For example, a neuromorphic processor may perform some or all of the steps of method 1700.

Embodiments of the mechanisms disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code may be applied to input instructions to perform the functions described herein and generate output information. The output information may be applied to one or more output devices, in known fashion. For purposes of this application, a processing system may include any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine-readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the disclosure may also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part-on and part-off processor.

Thus, techniques for performing one or more instructions according to at least one embodiment are disclosed. While certain exemplary embodiments have been described and shown in the accompanying drawings, it is to be understood that such embodiments are merely illustrative of and not restrictive on other embodiments, and that such embodiments not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

In some embodiments of the present disclosure, a neuromorphic processor may include a synapse coupled to a pre-synaptic neuron and coupled to a post-synaptic neuron. In combination with any of the above embodiments, a synapse may include a synapse memory to store a synapse weight. In combination with any of the above embodiments, a synapse may include a synapse spike timing dependent plasticity (STDP) circuit coupled to a synapse memory. In combination with any of the above embodiments, a pre-synaptic neuron may include a pre-synaptic neuron memory to store a pre-synaptic neuron spike history. In combination with any of the above embodiments, a pre-synaptic neuron may include a pre-synaptic neuron STDP circuit coupled to a pre-synaptic neuron memory, a pre-synaptic neuron STDP circuit to, in response to a pre-synaptic neuron firing, initiate performing long term depression. In combination with any of the above embodiments, a post-synaptic neuron may include a post-synaptic neuron memory storing a post-synaptic neuron spike history. In combination with any of the above embodiments, a post-synaptic neuron may include a post-synaptic neuron STDP circuit coupled to a post-synaptic neuron memory to, in response to a post-synaptic neuron firing, initiate performing long term potentiation.

In combination with any of the above embodiments, a neuromorphic processor of may include a post-synaptic neuron STDP circuit further to, as part of performing long term potentiation, overwrite a post-synaptic neuron spike history with a maximum value. In combination with any of the above embodiments, a neuromorphic processor of may include a post-synaptic neuron STDP circuit further to, as part of performing long term potentiation, transmit a signal indicating that the post-synaptic neuron has fired to a pre-synaptic neuron STDP circuit. In combination with any of the above embodiments, a neuromorphic processor of may include a pre-synaptic neuron STDP circuit further to, as part of performing long term potentiation, retrieve a pre-synaptic neuron spike history from a pre-synaptic neuron memory. In combination with any of the above embodiments, a neuromorphic processor of may include a pre-synaptic neuron STDP circuit further to, as part of performing long term potentiation determine a post-synaptic spike history based on signal indicating that the post-synaptic neuron has fired. In combination with any of the above embodiments, a neuromorphic processor of may include a pre-synaptic neuron STDP circuit further to, as part of performing long term potentiation calculate a synapse weight offset based on a pre-synaptic neuron spike history and a post-synaptic neuron spike history. In combination with any of the above embodiments, a neuromorphic processor of may include a pre-synaptic neuron STDP circuit further to, as part of performing long term potentiation, transmit a synapse weight offset to a synapse STDP circuit. In combination with any of the above embodiments, a neuromorphic processor of may include a synapse STDP circuit further to, as part of performing long term potentiation, update a synapse weight based on a synapse weight offset.

In combination with any of the above embodiments, a neuromorphic processor may include a pre-synaptic neuron STDP circuit to, as part of performing long term depression, overwrite a pre-synaptic neuron spike history with a maximum value. In combination with any of the above embodiments, a neuromorphic processor may include a pre-synaptic neuron STDP circuit to, as part of performing long term depression, transmit a signal indicating that the pre-synaptic neuron has fired to a post-synaptic neuron STDP circuit. In combination with any of the above embodiments, a neuromorphic processor may include a post-synaptic neuron STDP circuit to, as part of performing long term depression, retrieve a post-synaptic neuron spike history from a post-synaptic neuron memory. In combination with any of the above embodiments, a neuromorphic processor of may include a post-synaptic neuron STDP circuit further to, as part of performing long term potentiation determine a pre-synaptic spike history based on signal indicating that the pre-synaptic neuron has fired. In combination with any of the above embodiments, a neuromorphic processor may include a post-synaptic neuron STDP circuit to, as part of performing long term depression, calculate a synapse weight offset based on a pre-synaptic neuron spike history and a post-synaptic neuron spike history. In combination with any of the above embodiments, a neuromorphic processor may include a post-synaptic neuron STDP circuit to, as part of performing long term depression, transmit a synapse weight offset to a synapse STDP circuit. In combination with any of the above embodiments, a neuromorphic processor may include a synapse STDP circuit to, as part of performing long term depression, update a synapse weight based on a synapse weight offset. In combination with any of the above embodiments, a neuromorphic processor may include a synapse to transmit a signal indicating that the post-synaptic neuron has fired to a pre-synaptic neuron. In combination with any of the above embodiments, a neuromorphic processor may include a network on chip is to transmit a signal indicating that the pre-synaptic neuron has fired to a post-synaptic neuron.

In combination with any of the above embodiments, a neuromorphic processor may include a reward-based STDP circuit coupled to a post-synaptic neuron. In combination with any of the above embodiments, a neuromorphic processor may include a reward-based STDP circuit to transmit a neuron reward value to a post-synaptic neuron STDP circuit. In combination with any of the above embodiments, a neuromorphic processor may include a pre-synaptic neuron STDP circuit to, as part of performing long term potentiation transmit a neuron reward value to a pre-synaptic neuron STDP circuit. In combination with any of the above embodiments, a neuromorphic processor may include a pre-synaptic neuron STDP circuit to, multiply a synapse weight offset by a neuron reward value prior to transmitting a synapse weight offset to a synapse STDP circuit. In combination with any of the above embodiments, a neuromorphic processor may include a reward-based STDP circuit coupled to a post-synaptic neuron, a reward-based STDP circuit to transmit a neuron reward value to a post-synaptic neuron STDP circuit. In combination with any of the above embodiments, a neuromorphic processor may include a post-synaptic neuron STDP circuit to, as part of performing long term depression, multiply a synapse weight offset by a neuron reward value prior to transmission of a synapse weight offset to a synapse STDP circuit.

In some embodiments of the present disclosure, a neuromorphic processor logic unit may include a synapse coupled to a pre-synaptic neuron and coupled to a post-synaptic neuron. In combination with any of the above embodiments, the synapse may include a synapse memory to store a synapse weight. In combination with any of the above embodiments, the synapse may include a synapse spike timing dependent plasticity (STDP) circuit coupled to the synapse memory. In combination with any of the above embodiments, the synapse may include a pre-synaptic neuron. In combination with any of the above embodiments, a pre-synaptic neuron may include a pre-synaptic neuron memory to store a pre-synaptic neuron spike history. In combination with any of the above embodiments, a pre-synaptic neuron may include a pre-synaptic neuron STDP circuit coupled to the pre-synaptic neuron memory, the pre-synaptic neuron STDP circuit to, in response to the pre-synaptic neuron firing, initiate performing long term depression. In combination with any of the above embodiments, the synapse may include a post-synaptic neuron. In combination with any of the above embodiments, the post-synaptic neuron may include a post-synaptic neuron memory storing a post-synaptic neuron spike history. In combination with any of the above embodiments, the post-synaptic neuron may include a post-synaptic neuron STDP circuit coupled to the post-synaptic neuron memory to, in response to the post-synaptic neuron firing, initiate performing long term potentiation.

In combination with any of the above embodiments, a neuromorphic processor logic unit may include a post-synaptic neuron STDP circuit further to, as part of performing long term potentiation overwrite the post-synaptic neuron spike history with a maximum value. In combination with any of the above embodiments, a neuromorphic processor logic unit may include a post-synaptic neuron STDP circuit further to, as part of performing long term potentiation transmit a signal indicating that the post-synaptic neuron has fired to the pre-synaptic neuron STDP circuit. In combination with any of the above embodiments, a neuromorphic processor logic unit may include a pre-synaptic neuron STDP circuit further to, as part of performing long term potentiation retrieve the pre-synaptic neuron spike history from the pre-synaptic neuron memory. In combination with any of the above embodiments, a neuromorphic processor logic unit may include a pre-synaptic neuron STDP circuit further to, as part of performing long term potentiation determine a post-synaptic spike history based on signal indicating that the post-synaptic neuron has fired. In combination with any of the above embodiments, a neuromorphic processor logic unit may include a pre-synaptic neuron STDP circuit further to, as part of performing long term potentiation calculating a synapse weight offset based on the pre-synaptic neuron spike history and the post-synaptic neuron spike history. In combination with any of the above embodiments, a neuromorphic processor logic unit may include a pre-synaptic neuron STDP circuit further to, as part of performing long term potentiation transmit the synapse weight offset to the synapse STDP circuit. In combination with any of the above embodiments, a neuromorphic processor logic unit may include a synapse STDP circuit further to, as part of performing long term potentiation update the synapse weight based on the synapse weight offset.

In combination with any of the above embodiments, a neuromorphic processor logic unit may include a pre-synaptic neuron STDP circuit to, as part of performing long term depression overwrite the pre-synaptic neuron spike history with a maximum value. In combination with any of the above embodiments, a neuromorphic processor logic unit may include a pre-synaptic neuron STDP circuit to, as part of performing long term depression transmit the pre-synaptic neuron spike history to the post-synaptic neuron STDP circuit. In combination with any of the above embodiments, a neuromorphic processor logic unit may include a post-synaptic neuron STDP circuit to, as part of performing long term depression retrieve the post-synaptic neuron spike history from the post-synaptic neuron memory. In combination with any of the above embodiments, a neuromorphic processor logic unit may include a post-synaptic neuron STDP circuit to, as part of performing long term depression determine a pre-synaptic spike history based on signal indicating that the pre-synaptic neuron has fired. In combination with any of the above embodiments, a neuromorphic processor logic unit may include a post-synaptic neuron STDP circuit to, as part of performing long term depression calculate a synapse weight offset based on the pre-synaptic neuron spike history and the post-synaptic neuron spike history. In combination with any of the above embodiments, a neuromorphic processor logic unit may include a post-synaptic neuron STDP circuit to, as part of performing long term depression transmit the synapse weight offset to the synapse STDP circuit. In combination with any of the above embodiments, a neuromorphic processor logic unit may include a post-synaptic neuron STDP circuit to, as part of performing long term depression update the synapse weight based on the synapse weight offset. In combination with any of the above embodiments, a neuromorphic processor logic unit may include a synapse to transmit the post-synaptic neuron spike history to the pre-synaptic neuron. In combination with any of the above embodiments, a neuromorphic processor logic unit may include a network on chip to transmit the pre-synaptic neuron spike history to the pre-synaptic neuron.

In combination with any of the above embodiments, a neuromorphic processor logic unit may include a reward-based STDP circuit coupled to the post-synaptic neuron. In combination with any of the above embodiments, a reward-based STDP circuit may be to transmit a neuron reward value to the post-synaptic neuron STDP circuit. In combination with any of the above embodiments, a pre-synaptic neuron STDP circuit is to, as part of performing long term potentiation transmit the neuron reward value to the pre-synaptic neuron STDP circuit. In combination with any of the above embodiments, a pre-synaptic neuron STDP circuit is to, as part of performing long term potentiation multiply the synapse weight offset by the neuron reward value prior to transmitting the synapse weight offset to the synapse STDP circuit. In combination with any of the above embodiments, a neuromorphic processor logic unit may include a reward-based STDP circuit coupled to the post-synaptic neuron; the reward-based STDP circuit to transmit a neuron reward value to the post-synaptic neuron STDP circuit. In combination with any of the above embodiments, a neuromorphic processor logic unit may include a post-synaptic neuron STDP circuit to, as part of performing long term depression, multiply the synapse weight offset by the neuron reward value prior to transmitting the synapse weight offset to the synapse STDP circuit.

In some embodiments of the present disclosure, a method may include, in a neuromorphic processor, receiving a plurality of neuron inputs with a plurality of neurons, the plurality of neurons including a plurality of pre-synaptic neurons and a plurality of post-synaptic neurons. In combination with any of the above embodiments, a method may include processing the plurality of inputs with the plurality of input neurons. In combination with any of the above embodiments, a method may include performing long term potentiation based on a determination that at least one of the plurality of post-synaptic neurons has fired. In combination with any of the above embodiments, a method may include performing long term depression based on a determination that at least one of the plurality of pre-synaptic neurons has fired.

In combination with any of the above embodiments, a method may include overwriting a post-synaptic neuron spike history with a maximum value. In combination with any of the above embodiments, a method may include transmitting a signal indicating that a post-synaptic neuron has fired to a pre-synaptic neuron spike timing dependent plasticity (STDP) circuit in one of the plurality of pre-synaptic neurons. In combination with any of the above embodiments, a method may include determining a post-synaptic neuron spike history based on receiving the signal indicating that the post-synaptic neuron has fired. In combination with any of the above embodiments, a method may include retrieving a pre-synaptic neuron spike history from a pre-synaptic neuron memory. In combination with any of the above embodiments, a method may include calculating a synapse weight offset based on the pre-synaptic neuron spike history and the post-synaptic neuron spike history. In combination with any of the above embodiments, a method may include transmitting the synapse weight offset to a synapse STDP circuit. In combination with any of the above embodiments, a method may include updating the synapse weight based on the synapse weight offset.

In combination with any of the above embodiments, a method may include overwriting a pre-synaptic neuron spike history with a maximum value. In combination with any of the above embodiments, a method may include transmitting a signal indicating that a pre-synaptic neuron has fired to a post-synaptic neuron STDP circuit in one of the plurality of post-synaptic neurons. In combination with any of the above embodiments, a method may include determining a pre-synaptic neuron spike history based on receiving the signal indicating that the pre-synaptic neuron has fired. In combination with any of the above embodiments, a method may include retrieving a post-synaptic neuron spike history from a post-synaptic neuron memory. In combination with any of the above embodiments, a method may include calculating a synapse weight offset based on the pre-synaptic neuron spike history and the post-synaptic neuron spike history. In combination with any of the above embodiments, a method may include transmitting the synapse weight offset to the synapse STDP circuit. In combination with any of the above embodiments, a method may include updating the synapse weight based on the synapse weight offset.

In combination with any of the above embodiments, a method may include transmitting a neuron reward value to the pre-synaptic neuron STDP circuit. In combination with any of the above embodiments, a method may include multiplying the synapse weight offset by the neuron reward value prior to transmitting the synapse weight offset to the synapse STDP circuit. In combination with any of the above embodiments, a method may include transmitting a neuron reward value to a post-synaptic neuron STDP circuit. In combination with any of the above embodiments, a method may include multiplying the synapse weight offset by the neuron reward value prior to transmitting the synapse weight offset to the synapse STDP circuit. In combination with any of the above embodiments, a method may include wherein the post-synaptic neuron spike history is transmitted to the pre-synaptic neuron via a synapse.

In combination with any of the above embodiments, a neuromorphic processor may include a synapse means coupled to a pre-synaptic neuron means and coupled to a post-synaptic neuron means. In combination with any of the above embodiments, a synapse means may include a means to store a synapse weight. In combination with any of the above embodiments, a synapse means may include a synapse spike timing dependent plasticity (STDP) means coupled to a synapse memory means. In combination with any of the above embodiments, a pre-synaptic neuron means may include a pre-synaptic neuron memory means to store a pre-synaptic neuron spike history. In combination with any of the above embodiments, a pre-synaptic neuron means may include a pre-synaptic neuron STDP means coupled to a pre-synaptic neuron memory means. In combination with any of the above embodiments, a pre-synaptic neuron means may include a pre-synaptic neuron STDP means to, in response to a pre-synaptic neuron means firing, initiate performing long term depression. In combination with any of the above embodiments, a post-synaptic neuron means may include a post-synaptic neuron memory means storing a post-synaptic neuron spike history. In combination with any of the above embodiments, a post-synaptic neuron means may include a post-synaptic neuron STDP means coupled to a post-synaptic neuron memory means to, in response to a post-synaptic neuron means firing, initiate performing long term potentiation.

In combination with any of the above embodiments, a neuromorphic processor may include a post-synaptic neuron STDP means further to, as part of performing long term potentiation overwrite a post-synaptic neuron spike history with a maximum value. In combination with any of the above embodiments, a neuromorphic processor of may include a post-synaptic neuron STDP means further to, as part of performing long term potentiation transmit a signal indicating that a post-synaptic neuron has fired to a pre-synaptic neuron STDP means. In combination with any of the above embodiments, a neuromorphic processor of may include a pre-synaptic neuron STDP means further to, as part of performing long term potentiation, retrieve a pre-synaptic neuron spike history from a pre-synaptic neuron memory means. In combination with any of the above embodiments, a neuromorphic processor of may include a pre-synaptic neuron STDP means further to, as part of performing long term potentiation, determine a post-synaptic spike history based on a signal indicating that a post-synaptic neuron has fired. In combination with any of the above embodiments, a neuromorphic processor of may include a pre-synaptic neuron STDP means further to, as part of performing long term potentiation calculate a synapse weight offset based on a pre-synaptic neuron spike history and a post-synaptic neuron spike history. In combination with any of the above embodiments, a neuromorphic processor of may include a pre-synaptic neuron STDP means further to, as part of performing long term potentiation, transmit a synapse weight offset to a synapse STDP means. In combination with any of the above embodiments, a neuromorphic processor of may include a synapse STDP means further to, as part of performing long term potentiation, update a synapse weight based on a synapse weight offset.

In combination with any of the above embodiments, a neuromorphic processor may include a pre-synaptic neuron STDP means to, as part of performing long term depression, overwrite a pre-synaptic neuron spike history with a maximum value. In combination with any of the above embodiments, a neuromorphic processor may include a pre-synaptic neuron STDP means to, as part of performing long term depression, transmit a signal indicating that a pre-synaptic neuron means has fired to a post-synaptic neuron STDP means. In combination with any of the above embodiments, a neuromorphic processor may include a post-synaptic neuron STDP means to, as part of performing long term depression, retrieve a post-synaptic neuron spike history from a post-synaptic neuron memory means. In combination with any of the above embodiments, a neuromorphic processor may include a pre-synaptic neuron STDP means to, as part of performing long term depression, determine a pre-synaptic neuron spike history based on a signal indicating that a pre-synaptic neuron means has fired. In combination with any of the above embodiments, a neuromorphic processor may include a post-synaptic neuron STDP means to, as part of performing long term depression, calculate a synapse weight offset based on a pre-synaptic neuron spike history and a post-synaptic neuron spike history. In combination with any of the above embodiments, a neuromorphic processor may include a post-synaptic neuron STDP means to, as part of performing long term depression, transmit a synapse weight offset to a synapse STDP means. In combination with any of the above embodiments, a neuromorphic processor may include a synapse STDP means to, as part of performing long term depression, update a synapse weight based on a synapse weight offset. In combination with any of the above embodiments, a neuromorphic processor may include a synapse means to transmit a signal indicating that a post-synaptic neuron means has fired to a pre-synaptic neuron means. In combination with any of the above embodiments, a neuromorphic processor may include a network on chip means is to transmit a signal indicating that a pre-synaptic neuron means has fired to a post-synaptic neuron means.

In combination with any of the above embodiments, a neuromorphic processor may include a reward-based STDP means coupled to a post-synaptic neuron means. In combination with any of the above embodiments, a neuromorphic processor may include a reward-based STDP means to transmit a neuron reward value to a post-synaptic neuron STDP means. In combination with any of the above embodiments, a neuromorphic processor may include a pre-synaptic neuron STDP means to, as part of performing long term potentiation transmit a neuron reward value to a pre-synaptic neuron STDP means. In combination with any of the above embodiments, a neuromorphic processor may include a pre-synaptic neuron STDP means to, multiply a synapse weight offset by a neuron reward value prior to transmitting a synapse weight offset to a synapse STDP means. In combination with any of the above embodiments, a neuromorphic processor may include a reward-based STDP means coupled to a post-synaptic neuron, a reward-based STDP means to transmit a neuron reward value to a post-synaptic neuron STDP circuit. In combination with any of the above embodiments, a neuromorphic processor may include a post-synaptic neuron STDP means to, as part of performing long term depression, multiply a synapse weight offset by a neuron reward value prior to transmission of a synapse weight offset to a synapse STDP means.

What is claimed is:

1. A neuromorphic processor, comprising:
a synapse coupled to a pre-synaptic neuron and coupled to a post-synaptic neuron, the synapse including:
a synapse memory to store a synapse weight;
a synapse spike timing dependent plasticity (STDP) circuit coupled to the synapse memory;
the pre-synaptic neuron including:
a pre-synaptic neuron memory to store a pre-synaptic neuron spike history; and
a pre-synaptic neuron STDP circuit coupled to the pre-synaptic neuron memory, the pre-synaptic neuron STDP circuit to, in response to the pre-synaptic neuron firing, initiate performing long term depression;
the post-synaptic neuron including:
a post-synaptic neuron memory storing a post-synaptic neuron spike history;
a post-synaptic neuron STDP circuit coupled to the post-synaptic neuron memory to, in response to the post-synaptic neuron firing, initiate performing long term potentiation.

2. The neuromorphic processor of claim 1, wherein, as part of performing long term potentiation,
the post-synaptic neuron STDP circuit is further to:
overwrite the post-synaptic neuron spike history with a maximum value;
transmit a signal indicating that the post-synaptic neuron has fired to the pre-synaptic neuron STDP circuit;
the pre-synaptic neuron STDP circuit is further to:
retrieve the pre-synaptic neuron spike history from the pre-synaptic neuron memory;
determine a post-synaptic neuron spike history based on receiving the signal indicating that the post-synaptic neuron has fired;
calculate a synapse weight offset based on the pre-synaptic neuron spike history and the post-synaptic neuron spike history;
transmit the synapse weight offset to the synapse STDP circuit; and
the synapse STDP circuit is further to update the synapse weight based on the synapse weight offset.

3. The neuromorphic processor of claim 1, wherein, as part of performing long term depression:
the pre-synaptic neuron STDP circuit is further to:
overwrite the pre-synaptic neuron spike history with a maximum value;
transmit a signal indicating that the pre-synaptic neuron has fired to the post-synaptic neuron STDP circuit;
the post-synaptic neuron STDP circuit is further to:
retrieve the post-synaptic neuron spike history from the post-synaptic neuron memory;
determine a pre-synaptic neuron spike history based on receiving the signal indicating that the pre-synaptic neuron has fired;
calculate a synapse weight offset based on the pre-synaptic neuron spike history and the post-synaptic neuron spike history;
transmit the synapse weight offset to the synapse STDP circuit; and
the synapse STDP circuit is further to update the synapse weight based on the synapse weight offset.

4. The neuromorphic processor of claim 3, wherein the synapse is to transmit the signal indicating that the pre-synaptic neuron has fired to the pre-synaptic neuron.

5. The neuromorphic processor of claim 4, wherein a network on chip is to transmit the signal indicating that the pre-synaptic neuron has fired to the pre-synaptic neuron.

6. The neuromorphic processor of claim 2, further comprising:
a reward-based STDP circuit coupled to the post-synaptic neuron, the reward-based STDP circuit to transmit a neuron reward value to the post-synaptic neuron STDP circuit;
wherein the post-synaptic neuron STDP circuit is further to, as part of performing long term potentiation, transmit the neuron reward value to the pre-synaptic neuron STDP circuit; and
wherein the pre-synaptic neuron STDP circuit is further to, as part of performing long term potentiation, multiply the synapse weight offset by the neuron reward value prior to transmitting the synapse weight offset to the synapse STDP circuit.

7. The neuromorphic processor of claim 3, further comprising a reward-based STDP circuit coupled to the post-synaptic neuron, the reward-based STDP circuit to transmit a neuron reward value to the post-synaptic neuron STDP circuit;
wherein the post-synaptic neuron STDP circuit is further to, as part of performing long term depression, multiply the synapse weight offset by the neuron reward value prior to transmission of the synapse weight offset to the synapse STDP circuit.

8. A neuromorphic processor logic unit, comprising:
a synapse coupled to a pre-synaptic neuron and coupled to a post-synaptic neuron; the synapse including:
a synapse memory to store a synapse weight;
a synapse spike timing dependent plasticity (STDP) circuit coupled to the synapse memory;
the pre-synaptic neuron including:
a pre-synaptic neuron memory to store a pre-synaptic neuron spike history; and
a pre-synaptic neuron STDP circuit coupled to the pre-synaptic neuron memory, the pre-synaptic neuron STDP circuit to, in response to the pre-synaptic neuron firing, initiate performing long term depression;
the post-synaptic neuron including:
a post-synaptic neuron memory storing a post-synaptic neuron spike history;
a post-synaptic neuron STDP circuit coupled to the post-synaptic neuron memory to, in response to the post-synaptic neuron firing, initiate performing long term potentiation.

9. The neuromorphic processor logic unit of claim 8 wherein, as part of performing long term potentiation:
the post-synaptic neuron STDP circuit is further to:
overwrite the post-synaptic neuron spike history with a maximum value;
transmit a signal indicating that the post-synaptic neuron has fired to the pre-synaptic neuron STDP circuit;
the pre-synaptic neuron STDP circuit is further to:
retrieve the pre-synaptic neuron spike history from the pre-synaptic neuron memory;
determine a post-synaptic neuron spike history based on receiving the signal indicating that the post-synaptic neuron has fired;
calculate a synapse weight offset based on the pre-synaptic neuron spike history and the post-synaptic neuron spike history;
transmit the synapse weight offset to the synapse STDP circuit; and
the synapse STDP circuit is further to update the synapse weight based on the synapse weight offset.

10. The neuromorphic processor logic unit of claim 8 wherein, as part of performing long term depression:
the pre-synaptic neuron STDP circuit is further to:
overwrite the pre-synaptic neuron spike history with a maximum value;
transmit a signal indicating that the pre-synaptic neuron has fired to the post-synaptic neuron STDP circuit;
the post-synaptic neuron STDP circuit is further to,
retrieve the post-synaptic neuron spike history from the post-synaptic neuron memory;
determine a pre-synaptic neuron spike history based on receiving the signal indicating that the pre-synaptic neuron has fired;
calculate a synapse weight offset based on the pre-synaptic neuron spike history and the post-synaptic neuron spike history;
transmit the synapse weight offset to the synapse STDP circuit; and
the synapse STDP circuit is further to update the synapse weight based on the synapse weight offset.

11. The neuromorphic processor logic unit of claim 9 wherein the synapse is to transmit the signal indicating that the post-synaptic neuron has fired to the pre-synaptic neuron.

12. The neuromorphic processor logic unit of claim 10, wherein a network on chip is to transmit the signal indicating that the pre-synaptic neuron has fired to the pre-synaptic neuron.

13. The neuromorphic processor logic unit of claim 9, further comprising:
a reward-based STDP circuit coupled to the post-synaptic neuron; the reward-based STDP circuit to transmit a neuron reward value to the post-synaptic neuron STDP circuit;
wherein the post-synaptic neuron STDP circuit is further to, as part of performing long term potentiation, transmit the neuron reward value to the pre-synaptic neuron STDP circuit; and
wherein the pre-synaptic neuron STDP circuit is further to, as part of performing long term potentiation, multiply the synapse weight offset by the neuron reward value prior to transmitting the synapse weight offset to the synapse STDP circuit.

14. The neuromorphic processor logic unit of claim 10, further comprising
a reward-based STDP circuit coupled to the post-synaptic neuron; the reward-based STDP circuit to transmit a neuron reward value to the post-synaptic neuron STDP circuit; and
wherein the post-synaptic neuron STDP circuit is further to, as part of performing long term depression, multiply the synapse weight offset by the neuron reward value prior to transmitting the synapse weight offset to the synapse STDP circuit.

15. A method, comprising, in a neuromorphic processor:
receiving a plurality of neuron inputs with a plurality of neurons, the plurality of neurons including a plurality of pre-synaptic neurons and a plurality of post-synaptic neurons;
processing the plurality of inputs with the plurality of input neurons;
performing long term potentiation based on a determination that at least one of the plurality of post-synaptic neurons has fired; and
performing long term depression based on a determination that at least one of the plurality of pre-synaptic neurons has fired.

16. The method of claim 15, wherein performing long term potentiation comprises:
overwriting a post-synaptic neuron spike history with a maximum value;
transmitting a signal indicating that the post-synaptic neuron has fired to a pre-synaptic neuron spike timing dependent plasticity (STDP) circuit in one of the plurality of pre-synaptic neurons;
retrieving a pre-synaptic neuron spike history from a pre-synaptic neuron memory;
determining a post-synaptic neuron spike history based on receiving the signal indicating that the post-synaptic neuron has fired;
calculating a synapse weight offset based on the pre-synaptic neuron spike history and the post-synaptic neuron spike history;
transmitting the synapse weight offset to a synapse STDP circuit; and
updating the synapse weight based on the synapse weight offset.

17. The method of claim 15, wherein performing long term depression comprises:
overwriting a pre-synaptic neuron spike history with a maximum value;
transmitting a signal indicating that the pre-synaptic neuron has fired a post-synaptic neuron STDP circuit in one of the plurality of post-synaptic neurons;
retrieving a post-synaptic neuron spike history from a post-synaptic neuron memory;
determining a pre-synaptic neuron spike history based on receiving the signal indicating that the pre-synaptic neuron has fired;
calculating a synapse weight offset based on the pre-synaptic neuron spike history and the post-synaptic neuron spike history;
transmitting the synapse weight offset to the synapse STDP circuit; and
updating the synapse weight based on the synapse weight offset.

18. The method of claim 16, further comprising:
transmitting a neuron reward value to the pre-synaptic neuron STDP circuit; and
multiplying the synapse weight offset by the neuron reward value prior to transmitting the synapse weight offset to the synapse STDP circuit.

19. The method of claim 17, further comprising:
transmitting a neuron reward value to a post-synaptic neuron STDP circuit; and
multiplying the synapse weight offset by the neuron reward value prior to transmitting the synapse weight offset to the synapse STDP circuit.

20. The method of claim 16, wherein the signal indicating that the post-synaptic neuron has fired is transmitted to the pre-synaptic neuron via a synapse.
